(19) United States
(12) Patent Application Publication
(10) Pub. No.: US 2005/0094059 A1
(43) Pub. Date: May 5, 2005

(54) Display element

(75) Inventor: Takafumi Noguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/951,785

(22) Filed: Sep. 29, 2004

(30) Foreign Application Priority Data
Sep. 30, 2003 (JP) P.2003-341360

(51) Int. Cl. G02F 1/1335

(52) U.S. Cl. 349/106

(57) ABSTRACT

A display element for displaying full colors, having two colored layers including an upper colored layer and a lower colored layer which are laminated with each other, wherein the upper colored layer has two upper colored regions which are arranged optically in parallel to each other, the upper colored regions each containing a dye to display a different hue, and the lower colored layer has two lower colored regions which are arranged optically in parallel to each other, the lower colored regions each containing a dye to display a different hue.

This application is based on Japanese Patent application JP 2003-341360, filed Sep. 30, 2003, the entire content of which is hereby incorporated by reference.

### BACKGROUND OF THE INVENTION

1. Technical Field of the Invention

The present invention relates to a display element suitably used in a crystal liquid color display or the like.

2. Description of the Related Art

With the recent spread of mobile computing, displays have been demanded which are more lightweight, are thinner and need less electricity to work. In particular, there is growing interest in reflective color displays requiring no backlights. High resolution has been demanded for display elements used in the reflective color displays.

FIG. 10 shows a schematic diagram for illustrating a constitution of a related display element. A display element 100 comprises a pair of transparent or opaque substrates 113a and 113b, and an upper liquid crystal layer 111 and a lower liquid crystal layer 112 laminated between the pair of transparent or opaque substrates 113a and 113b. As shown in FIG. 10, a side on which incident light L is incident (the upper side in FIG. 10) with respect to a direction in which the liquid crystal layers 111 and 112 are laminated with each other (herein after referred to as a direction of lamination) is defined as an upper side, and the opposite side thereof is defined as a lower side.

The upper liquid crystal layer 111 is a guest-host liquid crystal layer in which three additive primary colors (red R, green G and blue B) are contained as a dichroic dye in a liquid crystal, and comprises a primary color region 111a in which red R is displayable, a primary color region 111b in which green G is displayable, and a primary color region 111c in which blue B is displayable. These primary color regions 111a, 111b and 111c are arranged optically in parallel to one another.

The lower liquid crystal layer 112 is a guest-host liquid crystal layer in which three subtractive primary colors (cyan C, magenta M and yellow Y) each standing in the relation of complimentary colors to the above-mentioned three additive primary colors are contained in the liquid crystal layer as a dichroic dye, and comprises a complimentary color region 112a which is disposed under the above-mentioned primary color region 111a in the direction of lamination and in which cyan C is displayable, a complimentary color region 112b which is disposed under the above-mentioned primary color region 111b in the direction of lamination and in which magenta M is displayable, and a complimentary color region 112c which is disposed under the above-mentioned primary color region 111c in the direction of lamination and in which yellow Y is displayable. These complimentary color regions 112a, 112b and 112c are arranged optically in parallel to one another (for example, JP-A-8-286215 (the term “JP-A” as used herein means an “unexamined published Japanese patent application”)).

By the way, when color display information is recognized through human eyes, it is known that it is generally possible to sufficiently identify a color as long as a degree of freedom of color expression is 3 or more.

The related display element 100 described above can display any one of the three primary colors R, G and B in each of the primary color regions 111a, 111b and 111c, and can add a contrast by the complimentary colors C, M and Y displayable in each of the complimentary color regions to the primary colors R, G and B displayed. When the number of displayable hues is taken as the degree of freedom of color display in such a display element, the display element 100 shown in FIG. 10 can display the above-mentioned 6 colors of red R, green G, blue B, cyan C, magenta M and yellow Y. Accordingly, the degree of freedom thereof is 6.

Further, the related display element 100 has three minimum color display elements comprising a single primary color region and a single complimentary color region disposed in the direction of lamination (the minimum color display element is hereinafter referred to as a pixel). That is to say, it has a so-called two-layer three-pixel structure.

Usually, in a display such as a color display, resolution depends on the number of allocatable display elements. Although the related display element 100 has room in the degree of freedom of color display, it has a structure requiring an area of 3 pixels in a section in which the display elements are arranged. Accordingly, color reproducibility is sufficient, but there is room for improvement in terms of resolution.

### SUMMARY OF THE INVENTION

The invention has been made in view of the above-mentioned situation, and an object of the invention is to provide a display element that can improve resolution while maintaining sufficient color reproducibility.

The above-mentioned object of the invention is achieved by a display element for displaying full colors, comprising two colored layers laminated with each other, wherein two upper colored regions each containing a dye to display different hue, are arranged optically in parallel to each other in one of the two colored layers, and two lower colored regions each containing a dye to display different hue, are arranged optically in parallel to each other in the other colored layer.

The display element according to the invention can have a degree of freedom of 3 or more by three hues of two hues displayed in the respective upper colored regions and a hue displayed by color mixture by placing the lower colored regions side by side.

Further, each colored layer has only two colored regions, so that the number of pixels is 2. Accordingly, the display element has a so-called two-layer two-pixel structure. It is therefore possible to decrease the number of pixels, compared to the related two-layer three-pixel display element described above. Consequently, the number of display elements allocatable in a definite section can be increased. Accordingly, the application of the display elements according to the invention to a display such as a color display can improve the resolution of the color display while maintaining sufficient color reproducibility, by allowing each display element to have a degree of freedom of 3 or more.

In the above-mentioned display element, it is preferred that all of the upper colored regions and the lower colored regions each display different hues. Thus, full colors can be displayed.

In the above-mentioned display element, of the upper colored regions and the lower colored regions, the regions arranged each other in a direction of lamination preferably have hues standing in the relation of complimentary colors to each other. Thus, a neutral color can be displayed by color mixture by superposition of the hues of the laminated regions.

Of the above-mentioned two upper colored regions, the hue displayed in one upper colored region is preferably green, and the hue displayed in the other upper colored region is preferably blue.

In the above-mentioned display element, when the dye displays cyan C, magenta M and yellow Y, which are the three subtractive primary colors, it becomes possible to mix two colors of these three subtractive primary colors to display any one of red R, green G and blue B, which are the three additive primary colors, as a hue. Then, these three additive primary colors make it possible to display full colors.

The term “color mixture by superposition” means that the hues of the colored regions in the respective liquid crystal layers laminated with each other are mixed in the direction of lamination.

According to the invention, the display element that can improve resolution can be provided while maintaining sufficient color reproducibility.

### BRIEF DESCRIPTION OF THE DRAWINGS

FIG. 1 is a schematic diagram showing one embodiment of a display element according to the invention.

FIG. 2A and FIG. 2B are schematic diagrams of showing hues displayed in respective colored regions of the display element shown in FIG. 1.

FIG. 3 is a diagram for illustrating the behavior of incident light and reflected light to a display element.

FIG. 4 is a schematic diagram for illustrating a state in which red is displayed in the display element 1 shown in FIG. 1.

FIG. 5 is a schematic diagram for illustrating a state in which green is displayed in the display element 1 shown in FIG. 1.

FIG. 6 is a schematic diagram for illustrating a state in which blue is displayed in the display element 1 shown in FIG. 1.

FIG. 7 is a schematic diagram showing a modification of the display element shown in FIG. 1.

FIG. 8 is a schematic diagram showing another modification of the display element shown in FIG. 1.

FIG. 9 is a diagram showing a display element of a comparative example.

FIG. 10 is a schematic diagram showing a two-layer three-pixel display element of the related art.

### DETAILED DESCRIPTION OF THE INVENTION

Embodiments of the invention will be described in detail below with reference to drawings.

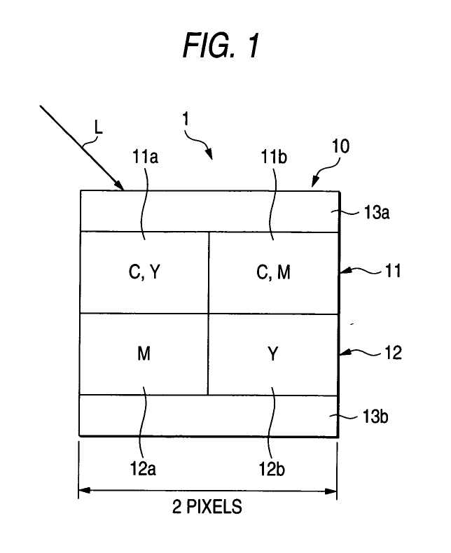

FIG. 1 is a schematic diagram optically showing one embodiment of a display element according to the invention. In schematic diagrams to which reference is made in the descriptions of the embodiments according to the invention, the dimensions of respective parts are indicated at a ratio different from the actual one.

A display element 1 of this embodiment is constituted by the aggregate of a plurality of picture elements 10. Each of these picture elements 10 roughly comprises a pair of transparent or opaque layers 13a and 13b, and colored layers 11 and 12 (which are liquid crystal layers in this embodiment, and hereinafter referred to as liquid crystal layers) laminated between the pair of transparent or opaque layers 13a and 13b. As shown in FIG. 1, the picture element 10 is irradiated with incident light L from an external light source from above with respect to a direction in which the liquid crystal layers 11 and 12 are laminated with each other (herein after referred to as a direction of lamination, or a lamination direction). The transparent or opaque layers 13a and 13b may each have an electrode.

Further, the display element 1 of this embodiment has such a constitution that full colors can be displayed, and is a liquid crystal display element using a so-called guest-host mode in which a dye (dichroic dye) different in absorbance between the major axis direction of a molecule and the minor axis direction thereof is added as a guest to the liquid crystal layers 11 and 12 as a host. In the guest-host mode, the alignment of the above-mentioned dye molecule is controlled by applied voltage through the alignment of a liquid crystal molecule. Like this, the alignment direction of the dye molecule is controlled by the application of voltage to change the intensity of light absorbed by the dye molecule, thereby adjusting displayed color.

In each picture element 10 of this embodiment, two upper colored regions 11a and 11b which display hues (primary colors) different from each other are arranged optically in parallel to each other (in FIG. 1, in a horizontal direction) in one liquid crystal layer 11, and two lower colored regions 12a and 12b which display hues (complimentary colors) different from each other are arranged optically in parallel to each other in the other liquid crystal layer 12. In the following description, the upper colored regions 11a and 11b and the lower colored regions 12a and 12b are also generically named a “colored region”.

In this embodiment, red R, green G and blue B, which are the three additive primary colors (R, G and B), are used as the primary colors, and cyan C, magenta M and yellow Y, which are three subtractive primary colors (C, M and Y) each standing in the relation of complimentary colors to these three additive primary colors are used as the complimentary colors. C, M and Y in drawings to which reference is made below mean cyan C, magenta M and yellow Y, respectively.

Each of the upper colored regions 11a and 11b in the liquid crystal layer 11 is formed of a guest-host liquid crystal (GH liquid crystal) in which any two of cyan C, magenta M and yellow Y of the three kinds of dyes are added as a guest to a liquid crystal as a host. In the display element 10 of this embodiment, the colored region 11a on the left in the liquid crystal layer 11 is constituted so that two kinds of dyes of cyan C and yellow Y are added as a guest to a liquid crystal as a host to conduct color mixture by superposition, thereby optically displaying green G. The colored region 11b on the right in the liquid crystal layer 11 is constituted so that two kinds of dyes of cyan C and magenta M are added as a guest to a liquid crystal as a host to conduct color mixture by superposition, thereby optically displaying blue B.

Each of the lower colored regions 12a and 12b in the liquid crystal layer 11 is formed of a guest-host liquid crystal in which any one of cyan C, magenta M and yellow Y of the three kinds of dyes are added as a guest to a liquid crystal as a host. In the display element 10 of this embodiment, the colored region 12a on the left in the liquid crystal layer 12 is constituted so that a dye of magenta M which is a complimentary color to green G displayed in the colored region 11a of the liquid crystal layer 11 positioned above in the direction of lamination is added as a guest to a liquid crystal as a host. The colored region 12b on the right in the liquid crystal layer 12 is constituted so that a dye of yellow Y which is a complimentary color to blue B displayed in the primary color region 11b of the liquid crystal layer 11 positioned above in the direction of lamination is added as a guest to a liquid crystal as a host.

Three kinds of dyes of cyan C, magenta M and yellow Y used in the display element 1 of this embodiment are color mixed, thereby forming a neutral color (neutral gray). The term “color mixture” as used herein means both color mixture by superposition in the direction of lamination of the liquid crystal layers and color mixture by placing the colored regions side by side. The dye used in the display element 1 is not limited to cyan C, magenta M and yellow Y, and may be any three kinds of dyes as long as they form a neutral color by color mixture.

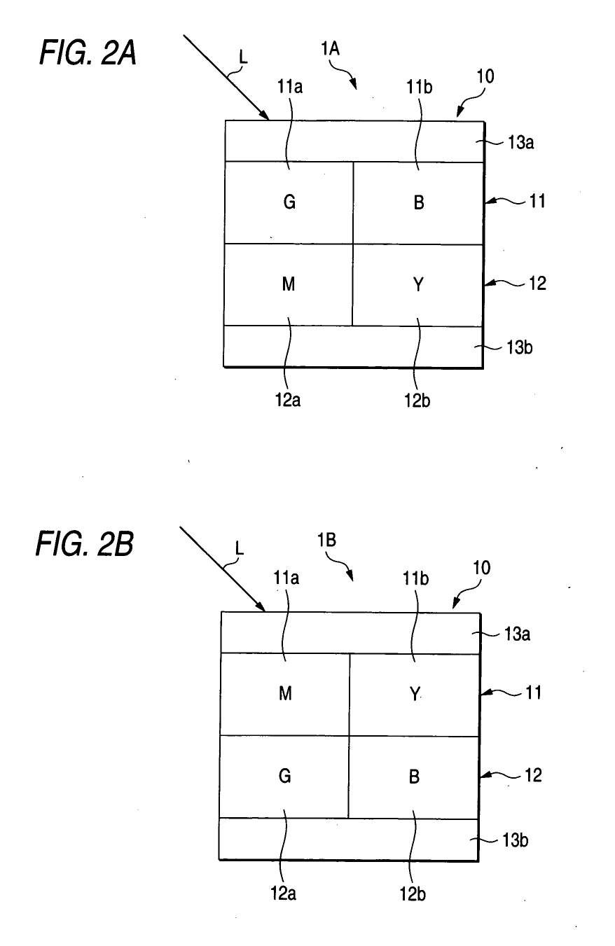

FIG. 2A is a schematic diagram showing hues displayed in respective regions in the display element 1 of one embodiment.

In the display element 1 of this embodiment, cyan C and yellow Y are contained in the upper colored region 11a of the liquid crystal layer 11, and these are substantially color mixed by superposition, thereby being able to display green G as a hue. Further, cyan C and magenta M are contained in the upper colored region 11b of the liquid crystal layer 11, and these are substantially color mixed by superposition, thereby being able to display blue B as a hue. Furthermore, both the lower colored regions 12a and 12b can display red R by color mixture of magenta M displayed in the lower colored region 12a and yellow Y displayed in the lower colored region 12b, which are placed side by side.

FIG. 2B is a schematic diagram showing hues displayed in respective regions in the display element 1 of another embodiment.

In the display element 1 of this embodiment, cyan C and yellow Y are contained in the lower colored region 12a of the liquid crystal layer 12, and these are substantially color mixed by superposition, thereby being able to display green G as a hue. Further, cyan C and magenta M are contained in the lower colored region 12b of the liquid crystal layer 12, and these are substantially color mixed by superposition, thereby being able to display blue B as a hue. Furthermore, both the upper colored regions 11a and 11b can display red R by color mixture of magenta M displayed in the upper colored region 11a and yellow Y displayed in the upper colored region 11b, which are placed side by side.

As described above, the display element 1 has such a constitution that cyan C, magenta M and yellow Y are color mixed by superposition and by placing them side by side, thereby making it possible to display full colors using red R, green G and blue B.

In the display element 1, the liquid crystal layers 11 and 12 are each provided with a driving element (not shown) in such a manner that each driving element is controllably driven, thereby being able to independently apply voltage to the respective colored regions 11a, 11b, 12a and 12b of the liquid crystal layers 11 and 12.

As a driving system of the display element 1, there is used an ordinary driving system such as a simple matrix driving system or an active matrix driving system using a thin film transistor (TFT), thereby being able to appropriately control the display of each picture element 10.

When the driving element is driven to apply voltage to each region, the alignment of the dichroic dye contained in the liquid crystal of each region varies. Like this, the display or non-display of a display color of each region is controlled by drive control of the driving element, and a color can be displayed for each picture element by color mixing a display color of the primary region and a display color of the complimentary region in the direction of lamination.

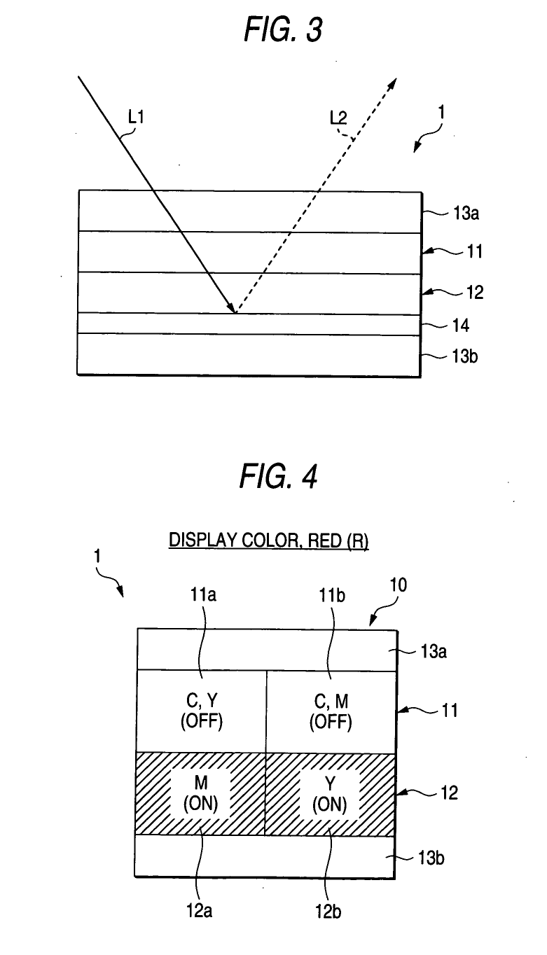

FIG. 3 is a diagram for illustrating a state in which incident light is transmitted and a state in which it is not transmitted, in the display element according to this embodiment. As shown in FIG. 3, a reflective layer 14 for reflecting incident light L to introduce it upward through the liquid crystal layer 11 is formed between the lower liquid crystal layer 12 and the transparent or opaque layer 13b disposed under the liquid crystal layer 12. When voltage is not applied to the upper colored region of the liquid crystal layer 11, the direction (major axis direction) of the dichroic dye in the liquid crystal is in parallel to the direction of lamination, which causes the state in which the incident light L is transmitted by the upper colored region (a state in which color development is OFF). As a result, a display color corresponding to the dye contained in the region of the liquid crystal layer 11 does not appear. At this time, when voltage is applied to the liquid crystal layer 12, the direction of the dichroic dye in the liquid crystal layer 12 becomes perpendicular to the direction of lamination (the vertical direction in FIG. 1) (a state in which color development is ON). Then, the incident light L is absorbed by the dichroic dye contained in the second liquid crystal layer 12, and thereafter reflected by the reflective layer 14 formed under the liquid crystal layer 12. Subsequently, it is transmitted by the first liquid crystal layer 11 again to form reflected light L2. Then, the reflected light L2 exhibits a hue of the dichroic dye contained in the liquid crystal layer 12. As a result, the display element 1 develops the hue of the dichroic dye (dye) contained in the liquid crystal layer 12 to the outside as a display color.

Referring to FIGS. 4, 5 and 6, a mechanism of displaying full colors with the display element of this embodiment will be described below.

FIG. 4 is a schematic diagram for illustrating a state in which red R is displayed in the display element 1 of the above-mentioned embodiment. In FIG. 4, the colored regions in which display colors are displayed are indicated by shaded portions.

When the desired picture element 10 is allowed to display red R in the display element 1, for example, voltage is not applied to both the upper colored regions 11a and 11b to form a state in which color development is OFF, and voltage is applied to both the lower colored regions 12a and 12b to form a state in which color development is ON. Then, magenta M appears in the lower colored region 12a, and yellow Y appears in the lower colored region 12b. Magenta M and yellow Y are color mixed by placing them side by side, thereby allowing red R to appear as a display color in the picture element 10.

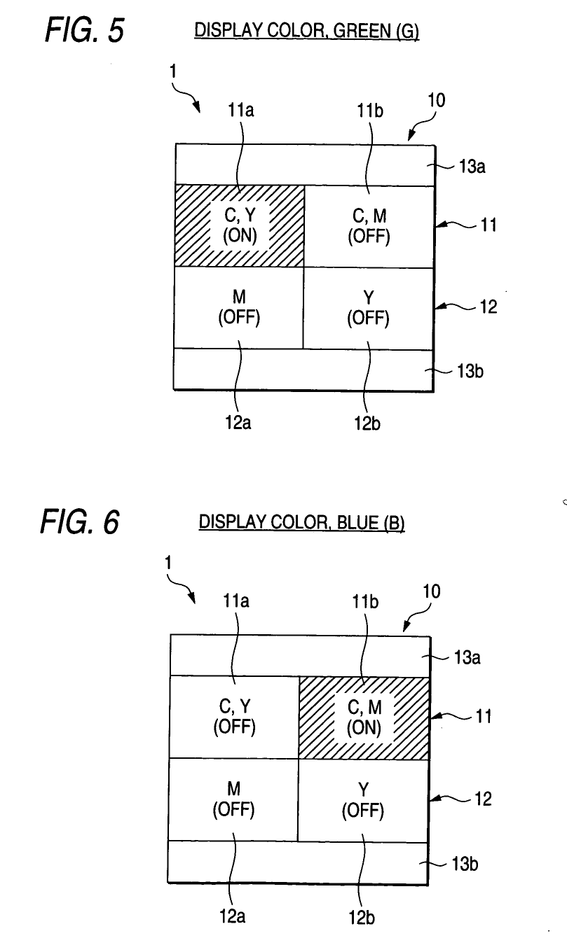

FIG. 5 is a schematic diagram for illustrating a state in which green G is displayed in the display element 1 of the above-mentioned embodiment. In FIG. 5, the colored regions in which display colors are displayed are indicated by shaded portions.

When the desired picture element 10 is allowed to display green G in the display element 1, for example, voltage is not applied to the upper colored region 11b and the lower colored regions 12a and 12b to form a state in which color development is OFF, and voltage is applied to the upper colored region 11a to form a state in which color development is ON. Then, cyan C and yellow Y are color mixed by superposition in the upper colored region 11a, thereby allowing green G to appear. Thus, green G appears as a display color in the picture element 10.

FIG. 6 is a schematic diagram for illustrating a state in which blue B is displayed in the display element 1 of the above-mentioned embodiment. In FIG. 6, the colored regions in which display colors are displayed are indicated by shaded portions.

When the desired picture element 10 is allowed to display blue B in the display element 1, for example, voltage is not applied to the upper colored region 11a and the lower colored regions 12a and 12b to form a state in which color development is OFF, and voltage is applied to the upper colored region 11b to form a state in which color development is ON. Then, cyan C and magenta M are color mixed by superposition in the upper colored region 11b, thereby allowing blue B to appear. Thus, blue B appears as a display color in the picture element 10.

In the display element 1 of the above-mentioned embodiment, when voltage is applied to all of the upper colored regions 11a and 11b and the lower colored regions 12a and 12b to form a state in which color development is ON, red R, green G and blue B are color mixed by superposition and by placing them side by side, thereby allowing a neutral color to appear in the picture element 10. The term “neutral color” as used herein means a hue (neutral gray) which appears by color mixture of hues obtained by developing all display colors of the regions of the respective liquid crystal layers.

The display element 10 according to the invention can have a degree of freedom of 3 or more by three hues of hues (green G and blue B) displayed in the upper colored regions 11a and 11b and a hue (red R) displayed by color mixture by placing the lower colored regions 12a and 12b side by side.

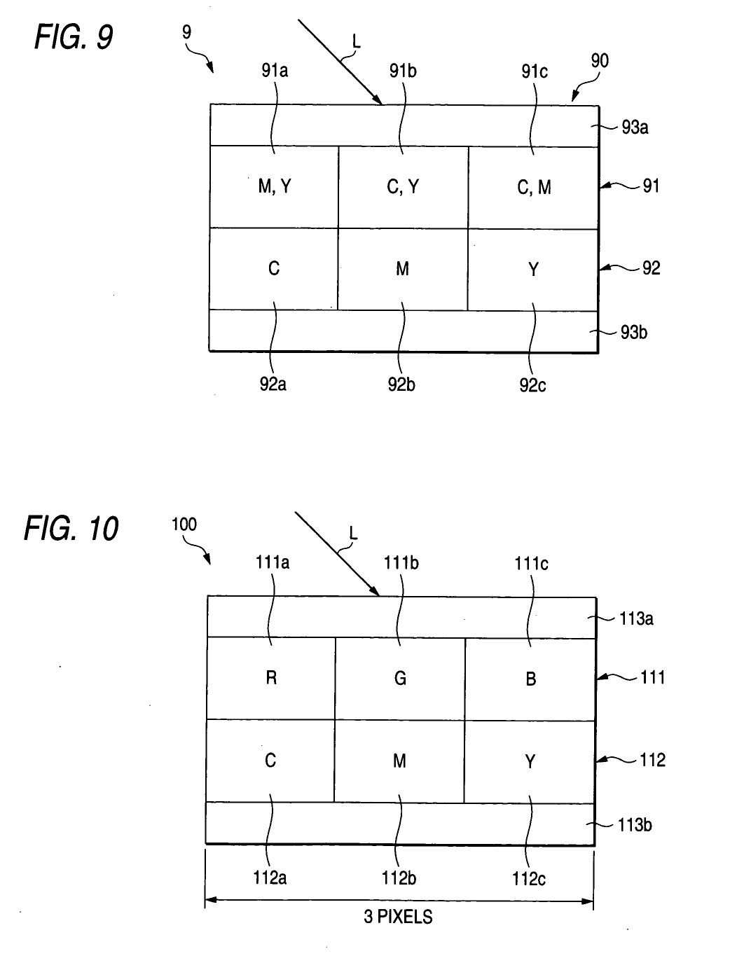

Further, as shown in FIG. 1, the liquid crystal layers 11 and 12 are each provided with only two colored regions 11a and 11b (or 12a and 12b), so that the number of pixels is 2. Accordingly, the display element 10 has a so-called two-layer two-pixel structure. It is therefore possible to decrease the number of pixels, compared to the two-layer three-pixel display element described above as a related art (see FIG. 9). Consequently, the display elements 10 can be disposed in larger numbers in a definite section, compared to the related display elements. Accordingly, the application of the display elements 10 according to the invention to a display such as a color display can improve the resolution of the color display while maintaining sufficient color reproducibility, by allowing each display element 10 to have a degree of freedom of 3 or more.

It is to be understood that the invention is not limited to the embodiment described above, and that appropriate changes and modifications are possible as described below.

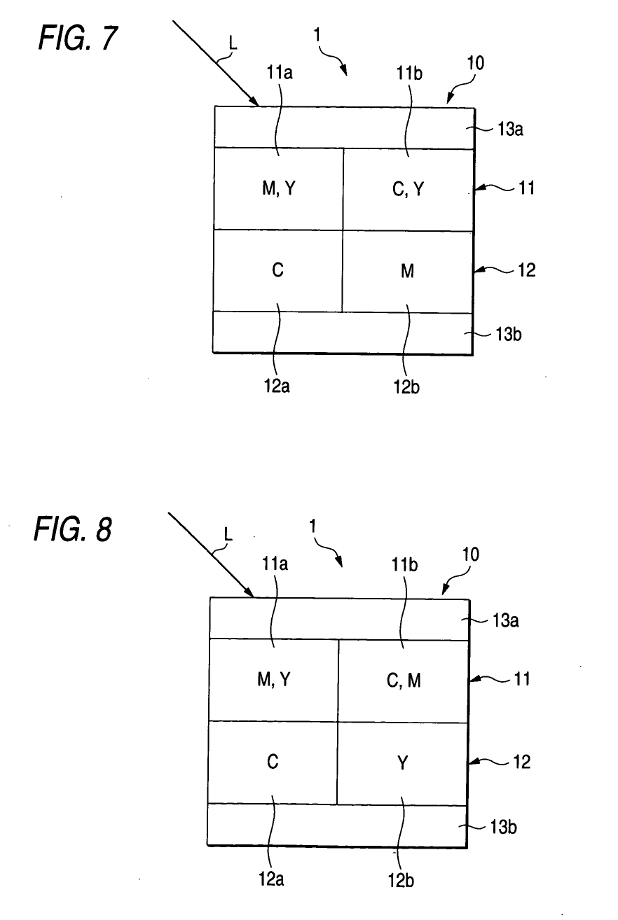

For example, the dye contained in the colored regions of the display element according to the invention can be appropriately changed. FIG. 7 is a schematic diagram showing a modification of the display element according to the invention. Further, FIG. 8 is a schematic diagram showing another modification of the display element according to the invention.

As shown in FIG. 7, the display element 10 has such a constitution that red is displayed by color mixture of magenta M and yellow Y by superposition in the upper colored region 11a, green by color mixture of cyan C and yellow Y by superposition in the upper colored region 11b, and blue by color mixture of cyan C contained in the lower colored region 12a and magenta M contained in the lower colored region 12b by placing them side by side.

Also the display element having the constitution shown in FIG. 7 can achieve an effect similar to that of the above-mentioned embodiment.

As shown in FIG. 8, the display element 10 has such a constitution that red is displayed by color mixture of magenta M and yellow Y by superposition in the upper colored region 11a, blue by color mixture of cyan C and magenta M by superposition in the upper colored region 11b, and green by color mixture of cyan C contained in the lower colored region 12a and yellow Y contained in the lower colored region 12b by placing them side by side.

Also the display element having the constitution shown in FIG. 8 can achieve an effect similar to that of the above-mentioned embodiment.

(Liquid Crystal Layer)

There is no particular limitation on the above-mentioned liquid crystal layer as long as two kinds of colored regions showing hues different from each other are arranged therein optically parallel to each other. In particular, it is preferred that the areas occupied by the two kinds of colored regions are each about ½ based on the total area of the liquid crystal layer. In the display element of the invention, the areas occupied by the two kinds of colored regions are each set to approximately ½ based on the total area of the liquid crystal layer, thereby providing the display element having sufficient brightness approximately uniformly ensured in any primary color display, particularly in the case of displaying a color image by two kinds of primary colors.

The term “approximately ½” means that the area is within the range of ½+1/9.

(Colored Region)

There is no particular limitation on the above-mentioned colored region, as long as it is a layer which can show three kinds of hues. However, from the viewpoint of the display element, it is particularly preferred that the region is reversibly decolorable and colorable.

The above-mentioned colored region is preferably reversibly decolorable and colorable, for example, by a stimulus such as an electric field, heat or a magnetic field, and it is preferred that the ratios of coloration/decoloration corresponding to the strength of stimulation in the respective colored regions are matched.

The above-mentioned colored regions include, for example, an electrochromic colored layer prepared using an electrochromic dye reversibly colored and decolored by electrochemical oxidation-reduction reaction and an electrolyte, as well as a guest-host type liquid crystal layer prepared by mixing a dichroic dye as a guest with a liquid crystal as a host. Of these, the former is particularly preferred in that the electric power consumption of the display element can be more decreased.

(Guest-Host Type Liquid Crystal Layer)

The guest-host type liquid crystal layer contains other components as needed, as well as the dichroic dye and the liquid crystal as a host.

(Dichroic Dye)

There is no particular limitation on the dichroic dye, and a dye having any chromophoric group may be used. Examples thereof include an azo dye, an anthraquinone dye, a perylene dye, a merocyanine dye, an azomethine dye, a phthaloperylene dye, an indigo dye, an azulene dye, a dioxazine dye and a polythiophene dye. Specific examples thereof include dyes described in Dichroic Dyes for Liquid Crystal Display (A. V. Ivashcinko, CRC, 1994). They may be used either alone or as a combination of two or more of them. Of these, an azo dye, an anthraquinone dye and a perylene dye are preferred, and an azo dye and an anthraquinone dye are particularly preferred. The dichroic dye is selected from dichroic dyes described in Liquid Crystal Device Handbook (edited by Japan Society for the Promotion of Science, 142nd Committee, 1989), pages 192 to 196 and pages 724 to 730. They may be used either alone or as a combination of two or more of them.

Of the dichroic dyes, as examples of dichroic dyes used in the guest-host type liquid crystal layer, there are reported, for example, azo dyes, anthraquinone dyes and perylene dyes shown below.

The azo dyes include, for example, azo dyes described in JP-A-53-26783, JP-A-53-75180, JP-A-54-68780, JP-A-55-52375, JP-A-58-79077, JP-A-59-24783, JP-A-60-184564, JP-A-61-123667, JP-A-62-252461, JP-A-5-59292, JP-A-5-59293, JP-A-5-59294, JP-A-6-157927, JP-A-6-256674, JP-A-7-224281, JP-A-8-143865, JP-A-9-143471, JP-A-10-95980 and JP-A-11-172252. They maybe used either alone or as a combination of two or more of them.

The anthraquinone dyes include, for example, anthraquinone dyes described in JP-A-56-38376, JP-A-57-96075, JP-A-57-190048, JP-A-57-198777, JP-A-57-198778, JP-A-57-205448, JP-A-58-185678, JP-A-62-64887, JP-A-62-64888, JP-A-2-67394, JP-A-2-69591, JP-A-2-178390, JP-A-7-76659, JP-A-7-247480, JP-A-7-252423 and JP-A-8-67822. They may be used either alone or as a combination of two or more of them.

The perylene dyes include, for example, perylene dyes described in JP-A-62-129380. They may be used either alone or as a combination of two or more of them.

The order parameter of the dichroic dye is preferably form 0.65 to 095, and more preferably from 0.75 to 0.95. The higher order parameter gives the better result.

The use of the dichroic dye having an order parameter within the above-mentioned numerical value range provides a color image display element in which sufficient contrast and brightness are compatible with each other.

When the molecular major axis of a molecule which receives thermal fluctuation inclines at a deviated angle θ to a director on time average, the above-mentioned order parameter is defined by the following equation (1):
Order Parameter (S)=(3 cos 2θ−1)/2 Equation (1)

When the order parameter (S) is 0 in the above-mentioned equation (1), it shows that the molecule is in a quite disordered state. When the order parameter (S) is 1, it shows that the molecule is in a state in which the molecular major axis is arranged in conformity with the direction of the director.

As described in the above-mentioned embodiment, the three additive primary colors are prepared by mixing two colors of the three subtractive primary colors corresponding thereto. Specific examples of the dichroic dyes of the three subtractive primary colors include dyes described in Liquid Crystal Device Handbook (edited by Japan Society for the Promotion of Science, 142nd Committee, 1989), page 789. Further, an optically active material such as a liquid crystal having an optically active center may be added.

Although there is no particular limitation on the content of the above-mentioned dichroic dye in the above-mentioned liquid crystal layer, it is preferably from 0.1 to 15% by weight, and more preferably from 0.5 to 6% by weight, based on the host liquid crystal.

(Liquid Crystal)

There is no particular limitation on the liquid crystal, as long as it is compatible with the dichroic dye. Examples thereof include a liquid crystal compound showing a nematic phase and a liquid crystal compound showing a smectic phase. Specific examples thereof include an azomethine compound, a cyanobiphenyl compound, a cyanophenyl ester, a fluorine-substituted phenyl ester, phenyl cyclohexanecarboxylate, fluorine-substituted phenyl cyclohexanecarboxylate, cyano-phenylpyrimidine, fluorine-substituted phenylcyclohexane, cyano-substituted phenylpyrimidine, fluorine-substituted phenylpyrimidine, alkoxyl-substituted phenylpyrimidine, fluorine-substituted alkoxyl-substituted phenylpyrimidine, phenyldioxane, a tolan-based compound, a fluorine-substituted tolan-based compound and an alkenylcyclohexylbenzonitrile. Further, they include side chain type polymer liquid crystal having a polyacrylate or a polysiloxane as a main chain, which are described in Liquid Crystal Device Handbook (edited by Japan Society for the Promotion of Science, 142nd Committee, 1989), pages 641 to 653, as well as various nematic liquid crystals and smectic liquid crystals having a cyano group, a fluorine atom and a chlorine atom, and having biphenyl or phenylcyclohexane as a skeleton, the liquid crystals having P-type or N-type dielectric anisotropy and being described in Liquid Crystal Device Handbook (edited by Japan Society for the Promotion of Science, 142nd Committee, 1989), pages 116 to 192. In this case, the liquid crystal may have the dichroic dye on a side chain thereof.

As an operation mode of the liquid crystal, a nematic-cholestric phase transition is preferred. However, the operation mode is not particularly limited thereto, and the liquid crystal having any operation mode may be used, as long as the direction of alignment of the dichroic dye is basically controllable according to the alignment of the liquid crystal molecule. For example, there are used a reflective liquid crystal display, a transmission liquid crystal display and a semi-transmission liquid crystal display. More specifically, there are used “homogeneous alignment” and “homeotropic alignment” described in a guest-host system described in Liquid Crystal Device Handbook (edited by Japan Society for the Promotion of Science, 142nd Committee, The NIKKAN KOGYO SHIMBUN, LTD, 1989), page 309, “focalconic alignment” and “homeotropic alignment” as a White-Taylor type (phase transition type), a combination with a “super twisted nematic (STN) system” and a combination with a ferroelectric liquid crystal (FLC). Further, the operation modes include a Heilmeier type GH mode, a λ/4 plate type GH mode, a two-layer type GH mode, a phase transition type GH mode and a polymer dispersion liquid crystal (PDLC) type GH mode described in General Techniques of Reflective Color LCD (supervised by Tatsuo Uchida, CMC, 1999), pages 15 and 16, Chapter 2-1 (GH mode Reflective Color LCD). Of these, a liquid crystal display in which homeotropic alignment is used as initial alignment by the λ/4 plate type GH mode is particularly preferred in that sufficient contrast is realizable.

(Other Components Contained in Liquid Crystal Layer)

In order to set physical properties of the above-mentioned host liquid crystal to the desired range, for example, in order to set the temperature range of a liquid crystal phase within the desired range, compounds showing no liquid crystallinity may be added as other components to the liquid crystal layer. Further, compounds such as a chiral compound, an UV absorber and an antioxidant may be added as other compounds. Such other components include, for example, a chiral agent for TN or STN described in Liquid Crystal Device Handbook (edited by Japan Society for the Promotion of Science, 142nd Committee, The NIKKAN KOGYO SHIMBUN, LTD, 1989), pages 199 to 202.

(Electrochromic Colored Layer)

There is no particular limitation on the electrochromic colored layer, and usually known electrochromic dyes and electrolytes can be used.

(Electrochromic Dye)

There is no particular limitation on the electrochromic dye, as long as it exhibits the function of coloring or decoloring by at least one of electrochemical oxidation reaction and reduction reaction, and it can be appropriately selected depending on its purpose. For example, an organic compound or a metal complex is suitably used. They may be used either alone or as a combination of two or more of them.

The metal complexes include, for example, Prussian blue, a metal-bipyridyl complex, a metal phenanthroline complex, a metal-phthalocyanine complex, a metaferricyanide and a derivative thereof.

The organic compounds include, for example, (1) pyridine compounds, (2) conductive polymers, (3) styryl compounds, (4) donor/acceptor type compounds and (5) other organic dyes.

The pyridine compounds (1) include, for example, viologen, heptyl viologen (such as diheptyl viologen dibromide), methylene bispyridinium, phenantoron, phenanthroline, azobipyridinium, 2,2-bipyridinium complex, quinoline and isoquinoline.

The conductive polymers (2) include, for example, polypyrrole, polythiophene, polyaniline, polyphenylenedi-amine, polyaminophenol, polyvinyl carbazole, a polymer viologen polyion complex, TTF and a derivative thereof.

The styryl compounds (3) include, for example, 2-[2-[4-(dimethlamino)phenyl]ethenyl]-3,3-dimethylindolino[2,1-b]oxazolidine, 2-[2-[4-(dimethylamino)phenyl]-1,3-butadienyl]-3,3-dimethylindolino[2,1-b]oxazolidine, 2-[2-[4-(di-methylamino)phenyl]ethenyl]-3,3-dimethyl-5-methylsulfonyl-indolino[2,1-b]oxazolidine, 2-[2-[4-(dimethylamino)-phenyl]-1,3-butadienyl]-3,3-dimethyl-5-sulfonylindolino-[2,1-b]oxazolidine, 3,3-dimethyl-2-[2-(9-ethyl-3-carbazol-yl)ethenyl]indolino[2,1-b]oxazolidine and 2-[2-[4-(acetylamino)phenyl]ethenyl]-3,3-dimethylindolino[2,1-b]oxazoli-dine.

The donor/acceptor type compounds (4) include, for example, tetracyanoquinodimethane and tetrathiafulvalene.

The other organic dyes (5) include, for example, carbazole, methoxybiphenyl, anthraquinone, quinone, diphenylamine, aminophenol, tris-aminophenylamine, phenylacetylene, a cyclopentyl compound, a benzodithiolium compound, a squalium salt, cyanine, a rare earth-phthalocyanine complex, ruthenium diphthalocyanine, merocyanine, a phenanthroline complex, pyrazoline, an oxidation reduction indicator, a pH indicator and a derivative thereof.

Of these, viologen dyes such as viologen and heptyl viologen (such as diheptyl viologen dibromide) are suitable.

There is no particular limitation on the combination at the time when two or more of the electrochromic dyes are used in combination include, and it can be appropriately selected depending on its purpose. Examples thereof include a combination of viologen and polyaniline, a combination of polypyrrole and polymethylthiophene and a combination of polyaniline and Prussian blue.

(Electrolyte)

The electrolytes include but are not limited to, for example, iodine, fluorine, metal halides such as LiI, NaI, KI, CsI, CaI₂, LiBr, NaBr, KBr, CsBr and CaBr₂, ammonium halides such as tetraethylammonium iodide, tetrapropylammonium iodide, tetrabutylammonium iodide, tetramethylammonium bromide, tetraethylammonium bromide and tetrabutylammonium bromide, alkyl viologens such as methyl viologen chloride and hexyl viologen bromide, polyhydroxybenzenes such as hydroquinone and naphthohydroquinone, and iron complexes such as ferrocene and a ferrocyanate.

In order to prevent mixing with another color in the liquid crystal layer, a partition wall-like boundary region may be provided in a boundary portion between the adjacent colored regions, and the boundary region may also serve as a cover for a periphery of the colored region such as a so-called black mask. The boundary region and the cover for the periphery of the colored region are preferably colorless, and may be provided on a substrate.

The thickness of the colored region is preferably from 1 to 100 μm, and more preferably from 1 to 50 μm.

(Other Constitution and Members)

Other constitution and members in the picture element include, for example, transparent or opaque layers such as a pair of substrates for protecting or holding the colored regions, an insulating film between the organic layers, a metal reflective plate, a retardation film, an orientated film, a light diffusing plate, an antireflective layer and a backlight. They may be used either alone or as a combination of two or more of them.

When the transparent or opaque layers form a pair of electrodes facing each other across the colored region, the display element of the invention can be used as an electro-optic device. In particular, when the colored region is a region prepared using the guest-host type liquid crystal layer prepared by mixing the dichroic dye as a guest with the liquid crystal as a host, the electrochromic dye reversibly colored and decolored by electrochemical oxidation-reduction reaction, and the electrolyte, the colored region is reversibly colorable and decolorable by forming the colored region between a pair of electrode substrates, and applying voltage to the colored region to control it. This embodiment is therefore preferred.

There is no particular limitation on the transparent or opaque layers, and they may be a layer relatively low in mechanical strength for the purpose of preventing or planarizing the colored region. However, it is preferred that at least one of the pair of transparent or opaque layers functions as a substrate or a base paper.

When the transparent or opaque layer is the electrode substrate, there is generally used an electrode substrate obtained by forming an electrode layer on a substrate made of glass, plastic, paper or metal. Materials for the plastic substrate include, for example, an acrylic resin, a polycarbonate resin and an epoxy resin. As these substrates, there can be used, for example, substrates described in Liquid Crystal Device Handbook (edited by Japan Society for the Promotion of Science, 142nd Committee, The NIKKAN KOGYO SHIMBUN, LTD, 1989), pages 218 to 231.

As the electrode layer, a transparent electrode layer is preferred. The electrode layer can be formed of, for example, indium oxide, indium tin oxide (ITO) or tin oxide. As the transparent electrode layers, there are used, for example, electrode layers described in Liquid Crystal Device Handbook (edited by Japan Society for the Promotion of Science, 142nd Committee, The NIKKAN KOGYO SHIMBUN, LTD, 1989), pages 232 to 239.

The display element of the invention may be provided with a diffusing plate and a backlight to form a transmission display, or provided with a reflective layer to form a reflective display. Further, it may be provided with a semi-transmission reflective layer to form such a structure as to be used both as transmission and reflection.

An electric field, heat or a magnetic field is allowed to act on the display element thus constituted, thereby being able to perform color display having a wide range of color reproducibility.

For example, when an electro-optic device is prepared using the ordinary nematic liquid crystal, the colored regions are put between the transparent layers or the substrates, an intermediate transparent layer is further provided between the liquid crystal layers, transparent electrodes are provided thereon, and the respective colored regions are selectively activated by known static drive or active drive using TFT to conduct additive color mixing, thereby being able to realize color display

The reflective layers include, for example, a reflective layer in which unevenness is formed on a surface of a substrate such as a white metal substrate. The reflective layer may also serve as an electrode. The use of the reflective layer thus provided with the unevenness lowers mirror reflection to inhibit the loss of light caused by total internal reflection, which causes the whiteness to increase and the problem of parallax such as a ghost image to be solved.

The reflective layer which also serves as the electrode can be obtained by forming a thin film of a white metal such as aluminum, silver or nickel on a base material of the reflective layer by vapor deposition or sputtering. The unevenness is formed on the surface of the base material by various methods such as a method of pressing a press die or a roll having unevenness on the substrate, a method of conducting polymerization in a die having unevenness, and a method of irradiating a photopolymerizable polymer material with lights different in the optical intensity distribution.

Using a metal plate having unevenness, the electrode may serves as the substrate or the base material of the reflective layer. The electrode serving as the reflective layer may be separated for each region to be electrically independent.

As a specific method for forming the electrode serving as the reflective layer on an active element such as TFT, there is applicable, for example, a method described in JP-A-5-281533. Further, using a mirror reflection plate instead of the reflective layer provided with the unevenness, a light diffusing plate according to a forward scattering plate is provided between the colored regions and the substrate, thereby also obtaining a similar effect.

There is no particular limitation on the size of the picture element, and the normal size (about 0.35 mm×0.35 mm) is preferred. Further, there is no particular limitation on the shape of the picture element, and the usually known shape, for example, a square, is used. The number of the picture elements varies depending on the use of the display element, and there is no particular limitation thereon, as long as it is within the range usually known as the number of the picture elements of the display element.

(Method for Producing Display Element)

Examples of methods for forming the lower liquid crystal layer of the liquid crystal layers to be laminated include a method of microencapsulating a guest-host liquid crystal composition for the primary colors appropriately containing an optically active material by a known method such as a coacervation method, mixing the resulting microcapsules with a polymer binder to prepare a primary color ink, and applying the ink onto the substrate to form the liquid crystal layer so as to have repetition of the colored regions of the three primary colors, and a method of using guest-host liquid crystal-containing microcapsules instead of a pigment, and applying the microcapsules onto the substrate to form the liquid crystal layer so as to have repeating units of the three primary colors, in a method known as a print method or a pigment dispersing method, of known methods for producing a color filter for a liquid crystal, such as a method of sequentially covering unnecessary portions with a resist and sequentially applying respective primary color inks.

The encapsulation of the guest-host liquid crystal and printing are each conducted by various known methods. Specific examples thereof include methods described in JP-T-62-502780 (the term “JP-T” as used herein means a published Japanese translation of a PCT patent application) and JP-A-6-34949, and further include a method of applying a guest-host liquid crystal and a polymer matrix, or an encapsulated guest-host liquid crystal and a polymer matrix by electrodeposition, according to a method described as an electrodeposition coating method in JP-A-6-34949 described above, thereby forming the liquid crystal layer so as to have repeating units of the three primary colors.

The lower liquid crystal layer to be laminated is formed as described above, and then, a transparent layer may be provided thereon to form an intermediate transparent layer. Further, stripe-shaped partition walls may be previously formed between the substrate and the intermediate transparent layer, and a guest-host liquid crystal of the primary colors may be held therebetween so as to have repeating units of the three primary colors. Repeating patterns of the primary colors include a stripe-shaped pattern and a mosaic-shaped pattern.

For example, the upper liquid crystal layer to be laminated can be formed on the lower liquid crystal layer in the same manner as described above. A transparent layer may be further formed thereon.

Further, the respective coloring regions may be previously formed on transparent layers, which are adhered to each other to form the liquid crystal element of the invention.

In order to account for the effect of the display element according to the invention, the degree of coincidence ε was measured using an example and a comparative example as described below to confirm color reproducibility.

As the dichroic dyes for complimentary colors, cyan C, magenta M and yellow Y, which can be used in this example, dyes described in JP-A-2003-138262 are available. They will be described in detail below.

In the invention, the above-mentioned dichroic dye has at least one substituent group represented by the following general formula (a):
-(Het)ₘ-{(B¹)ₚ-(Q¹)_{q}-(B²)ᵣ}ₙ—C¹ (a)

In the above-mentioned general formula (a), Het represents a sulfur atom or an oxygen atom, and B¹ and B² each represents a divalent aryl, heteroaryl or alicyclic hydrocarbon group. The above-mentioned divalent aryl group is preferably an aryl group having 2 to 20 carbon atoms. Specifically, a divalent group of a benzene ring, a naphthalene ring or an anthracene ring is preferred. Particularly preferred is a divalent group of a benzene ring or a substituted benzene ring, and more preferred is a 1,4-phenylene group. The heteroaryl group represented by each of B¹ and B² is preferably a heteroaryl group having 1 to 20 carbon atoms. Specifically, a divalent heteroaryl group of a pyridine ring, a quinoline ring, an isoquinoline ring, a pyrimidine ring, a pyrazine ring, a thiophene ring, a furan ring, an oxazole ring, a thiazole ring, an imidazole ring, a pyrazole ring, an oxadiazole ring, a thiadiazole ring, a triazole ring or a condensed ring obtained by cyclocondensation thereof. Preferred examples of the alicyclic hydrocarbon groups represented by each of B¹ and B² include a cyclohexane-1,2-diyl group, a cyclohexane-1,3-diyl group, a cyclohexane-1, 4-diyl group and cyclopentane-1, 3-diyl group, and particularly preferred is a (E)-cyclohexane-1,4-diyl group.

B¹ and B² may each has a substituent group, which is any one selected from the following group of substituent groups V:
The substituent groups V include a halogen atom (for example, chlorine, bromine, iodine or fluorine); a mercapto group; a cyano group; a carboxyl group; a phosphoric acid group; a sulfo group; a hydroxyl group; a carbamoyl group having 1 to 10 carbon atoms, preferably 2 to 8 carbon atoms, and more preferably 2 to 5 carbon atoms (for example, a methylcarbamoyl group, an ethylcarbamoyl group or a morpholinocarbamoyl group); a sulfamoyl group having 0 to 10 carbon atoms, preferably 2 to 8 carbon atoms, and more preferably 2 to 5 carbon atoms (for example, a methylsulfamoyl group, an ethylsulfamoyl group or a piperidinosulfamoyl group); a nitro group; an alkoxyl group having 1 to 20 carbon atoms, preferably 1 to 10 carbon atoms, and more preferably 1 to 8 carbon atoms (for example, a methoxy group, an ethoxy group, a 2-methoxyethoxy group or a 2-phenylethoxy group); an aryloxy group having 6 to 20 carbon atoms, preferably 6 to 12 carbon atoms, and more preferably 6 to 10 carbon atoms (for example, a phenoxy group, a p-methyl-phenoxy group, a p-chlorophenoxy group or a naphthoxy group); an acyl group having 1 to 20 carbon atoms, preferably 2 to 12 carbon atoms, and more preferably 2 to 8 carbon atoms (for example, an acetyl group, a benzoyl group or a trichloroacetyl group); an acyloxy group having 1 to 20 carbon atoms, preferably 2 to 12 carbon atoms, and more preferably 2 to 8 carbon atoms (for example, an acyloxy group or a benzoyloxy group); an acylamino group having 1 to 20 carbon atoms, preferably 2 to 12 carbon atoms, and more preferably 2 to 8 carbon atoms (for example, an acetylamino group); a sulfonyl group having 1 to 20 carbon atoms, preferably 1 to 10 carbon atoms, and more preferably 1 to 8 carbon atoms (for example, a methanesulfonyl group, an ethanesulfonyl group or a benzenesulfonyl group); a sulfinyl group having 1 to 20 carbon atoms, preferably 1 to 10 carbon atoms, and more preferably 1 to 8 carbon atoms (for example, a methanesulfinyl group, an ethanesulfinyl group or a benzenesulfinyl group); a sulfonylamino group having 1 to 20 carbon atoms, preferably 1 to 10 carbon atoms, and more preferably 1 to 8 carbon atoms (for example, a methane-sulfonylamino group, an ethanesulfonylamino group or a benzenesulfonyl group);
a substituted or unsubstituted amino group having 0 to 20 carbon atoms, preferably 0 to 12 carbon atoms, and more preferably 0 to 8 carbon atoms (for example, an unsubstituted amino group, a methylamino group, a dimethylamino group, a benzylamino group, an anilino group, a diphenylamino group, a 4-methylphenylamino group, a 4-ethylphenylamino group, a 3-n-propylphenylamino group, a 4-n-propylphenylamino group, a 3-n-butylphenylamino group, a 4-n-butylphenylamino group, a 3-n-pentylphenylamino group, a 4-n-pentylphenylamino group, a 3-tolylfluoromethylphenylamino group, a 4-tolylfluoro-methylphenylamino group, a 2-pyridylamino group, a 3-pyridylamino group, a 2-thiazolylamino group, a 2-oxazolylamino group, an N,N-methylphenylamino group or an N,N-ethylphenylamino group); an ammonium group having 0 to 15 carbon atoms, preferably 3 to 10 carbon atoms, and more preferably 3 to 6 carbon atoms (for example, a trimethylammonium group or a triethylammonium); a hydrazino group having 0 to 15 carbon atoms, preferably 1 to 10 carbon atoms, and more preferably 1 to 6 carbon atoms (for example, a trimethylhydrazino group); a ureido group having 1 to 15 carbon atoms, preferably 1 to 10 carbon atoms, and more preferably 1 to 6 carbon atoms (for example, a ureido group or an N,N-dimethylureido group); an imido group having 0 to 15 carbon atoms, preferably 1 to 10 carbon atoms, and more preferably 1 to 6 carbon atoms (for example, a succinimido group); an alkylthio group having 1 to 20 carbon atoms, preferably 1 to 12 carbon atoms, and more preferably 1 to 8 carbon atoms (for example, a methylthio group, an ethylthio group or a propylthio group); an arylthio group having 6 to 80 carbon atoms, preferably 6 to 40 carbon atoms, and more preferably 6 to 30 carbon atoms (for example, a phenylthio group, a p-methylphenylthio group, a p-chlorophenylthio group, a 1-naphthylthio group, a 2-naphthylthio group, a 4-propylcyclohexyl-4′-biphenylthio group, a 4-butylcyclohexyl-4′-biphenylthio group, a 4-pentylcyclohexyl-4′-biphenylthio group or a 4-propylphenyl-2-ethynyl-4′-biphenylthio group); a heteroarylthio group having 1 to 80 carbon atoms, preferably 1 to 40 carbon atoms, and more preferably 1 to 30 carbon atoms (for example, a 2-pyridylthio group, a 3-pyridylthio group, a 4-pyridylthio group, a 2-quinolylthio group, a 2-furylthio group or a 2-pyrrolylthio group);

an alkoxycarbonyl group having 2 to 20 carbon atoms, preferably 2 to 12 carbon atoms, and more preferably 2 to 8 carbon atoms (for example, a methoxycarbonyl group, an ethoxycarbonyl group or a 2-benzyloxycarbonyl group); an aryloxycarbonyl group having 6 to 20 carbon atoms, preferably 6 to 12 carbon atoms, and more preferably 6 to 10 carbon atoms (for example, a phenoxycarbonyl group) ; an unsubstituted alkyl group having 1 to 18 carbon atoms, preferably 1 to 10 carbon atoms, and more preferably 1 to 5 carbon atoms (for example, a methyl group, an ethyl group, a propyl group or a butyl group); a substituted alkyl group having 1 to 18 carbon atoms, preferably 1 to 10 carbon atoms, and more preferably 1 to 5 carbon atoms (for example, a hydroxymethyl group, a trifluoromethyl group, a benzyl group, a carboxyethyl group, an ethoxycarbonylmethyl group or an acetylaminomethyl group), which shall be considered to include an unsaturated hydrocarbon group having 2 to 18 carbon atoms, preferably 3 to 10 carbon atoms, and more preferably 3 to 5 carbon atoms (for example, a vinyl group, an ethynyl group, a 1-cyclohexenyl group, a benzylidyne group or a benzylidene group); a substituted or unsubstituted aryl group having 6 to 20 carbon atoms, preferably 6 to 15 carbon atoms, and more preferably 6 to 10 carbon atoms (for example, a phenyl group, a naphthyl group, a p-carboxyphenyl group, a p-nitrophenyl group, a 3,5-dichlorophenyl group, a p-cyanophenyl group, a m-fluorophenyl group, a p-tolyl group, a 4-propylcyclohexyl-4′-biphenyl group, a 4-butylcyclohexyl-4′-biphenyl group, a 4-pentylcyclohexyl-4′-biphenyl group or a 4-propylphenyl-2-ethynyl-4′-biphenyl group); and a substituted or unsubstituted heterocyclic group having 1 to 20 carbon atoms, preferably 2 to 10 carbon atoms, and more preferably 4 to 6 carbon atoms (for example, a pyridyl group, a 5-methylpyridyl group, a thienyl group, a furyl group, a morpholino group or a tetrahydrofuryl group). These substituent groups V may also be a group having a structure in which benzene rings or naphthalene rings are condensed. In addition, these substituent groups V may further have any one substituent group selected from the group of substituent groups V.

The substituent groups V are preferably the above-mentioned alkyl group, aryl group, alkoxyl group, aryloxy group, halogen atom, unsubstituted amino group, substituted amino group, hydroxyl group, alkylthio group and arylthio group, and more preferably the alkyl group, aryl group and halogen atom.

In the above-mentioned general formula (a), Q¹ represents a divalent connecting group. Preferably, it represents a divalent connecting group comprising an atomic group composed of atoms selected from carbon, nitrogen, sulfur and oxygen atoms. The above-mentioned divalent connecting groups include an alkylene group having 1 to 20 carbon atoms (for example, a methylene group, an ethylene group, a propylene group, a butylene group, a pentylene group or a cyclohexyl-1,4-diyl group); an alkenylene group having 2 to 20 carbon atoms (for example, an ethenylene group); an alkynylene group having 2 to 20 carbon atoms (for example, an ethynylene group); an amido group; an ether group; an ester group; a sulfoamido group; a sulfonic acid ester group; a ureido group; a sulfonyl group; a sulfinyl group; a thioether group; a carbonyl group; an —NR— group (wherein R represents a hydrogen atom, an alkyl group or an aryl group); an azo group; an azoxy group; a divalent heterocyclic group (for example, a piperazine-1,4-diyl group); and a divalent connecting group having 0 to 60 carbon atoms composed of a combination of two or more of them. Q¹ preferably represents an alkylene group, an alkenylene group, an alkynylene group, an ether group, a thioether group, an amido group, an ester group, a carbonyl group or a divalent connecting group composed of a combination thereof. Q¹ may further have a substituent group, which includes any one substituent group selected from the above-mentioned group of substituent groups V.

In the above-mentioned general formula (a), C¹ represents an alkyl group, a cycloalkyl group, an alkoxyl group, an acyl group, an alkoxycarbonyl group or an acyloxy group. Preferred examples thereof include alkyl and cycloalkyl groups having 1 to 30 carbon atoms, preferably 1 to 12 carbon atoms, and more preferably 1 to 8 carbon atoms (for example, a methyl group, an ethyl group, a propyl group, a butyl group, a t-butyl group, an i-butyl group, a s-butyl group, a pentyl group, a t-pentyl group, a hexyl group, a heptyl group, an octyl group, a cyclohexyl group, a 4-methylcyclohexyl group, a 4-ethylcyclohexyl group, a 4-propylcyclohexyl group, a 4-butylcyclohexyl group, a 4-pentylcyclohexyl group, a hydroxymethyl group, a tri-fluoromethyl group or a benzyl group); an alkoxyl group having 1 to 20 carbon atoms, preferably 1 to 10 carbon atoms, and more preferably 1 to 8 carbon atoms (for example, a methoxy group, an ethoxy group, a 2-methoxyethoxy group or a 2-phenylethoxy group); an acyl group having 1 to 20 carbon atoms, preferably 2 to 12 carbon atoms, and more preferably 2 to 8 carbon atoms (for example, an acetyl group, a pivaloyl group or a formyl group); an acyloxy group having 1 to 20 carbon atoms, preferably 2 to 12 carbon atoms, and more preferably 2 to 8 carbon atoms (for example, an acetyloxy group or a benzoyloxy group); and an alkoxycarbonyl group having 2 to 20 carbon atoms, preferably 2 to 12 carbon atoms, and more preferably 2 to 8 carbon atoms (for example, a methoxycarbonyl group, an ethoxycarbonyl group or a2-benzyloxycarbonyl group). C¹ is particularly preferably an alkyl group or an alkoxyl group, and more preferably an ethyl group, a propyl group, a butyl group, a pentyl group, a hexyl group or a trifluoromethoxy group. C¹ may further have a substituent group, which includes any one substituent group selected from the above-mentioned group of substituent groups V.

In the above-mentioned general formula (a), m represents 0 or 1, and preferably 1. p, q and r each represents an integer of 0 to 5, and n represents an integer of 1 to 3. However, (p+r)×n=3 to 10 is satisfied. When p, q, r and n are each 2 or more, the repeating units thereof maybe the same or different. Preferred combinations of p, q, r and n are described below:
(1) p=2, q=0, r=1, n=1
(2) p=3, q=0, r=0, n=1
(3) p=4, q=0, r=0, n=1
(4) p=5, q=0, r=0, n=1
(5) p=2, q=1, r=1, n=1
(6) p=1, q=1, r=2, n=1
(7) p=3, q=1, r=1, n=1
(8) p=1, q=1, r=3, n=1
(9) p=2, q=1, r=2, n=1
(10) p=1, q=1, r=1, n=3
(11) p=0, q=1, r=3, n=1
(12) p=0, q=1, r=2, n=2
(13) p=1, q=1, r=2, n=2
(14) p=2, q=1, r=1, n=2

Particularly preferred are the combinations of (1) p=2, q=0, r=1, n=1, (2) p=3, q=0, r=0, n=1, (3) p=4, q=0, r=0, n=1, and (5) p=2, q=1, r=1, n=1.

It is preferred that —{(B¹)ₚ-(Q¹)_{q}-(B²)ᵣ}ₙ—C¹ contains a structure showing liquid crystallinity. Although the phase of the liquid crystal used herein may be any, it is preferably a nematic liquid crystal, a smectic liquid crystal or a discotic liquid crystal, more preferably a nematic liquid crystal or a smectic liquid crystal, and particularly preferably a nematic liquid crystal. Specific examples of liquid crystal compounds include compounds described in Liquid Crystal Handbook edited by the editorial committee of Liquid Crystal Handbook, Maruzen, 2000, Chapter 3, “Molecular Structure and Liquid Crystallinity”.

Specific examples of the compounds represented by —{(B¹)ₚ-(Q¹)_{q}-(B²)ᵣ}ₙ—C¹ are shown below, but the invention is not limited thereto (in the following formulas, wavy lines indicate connecting positions).

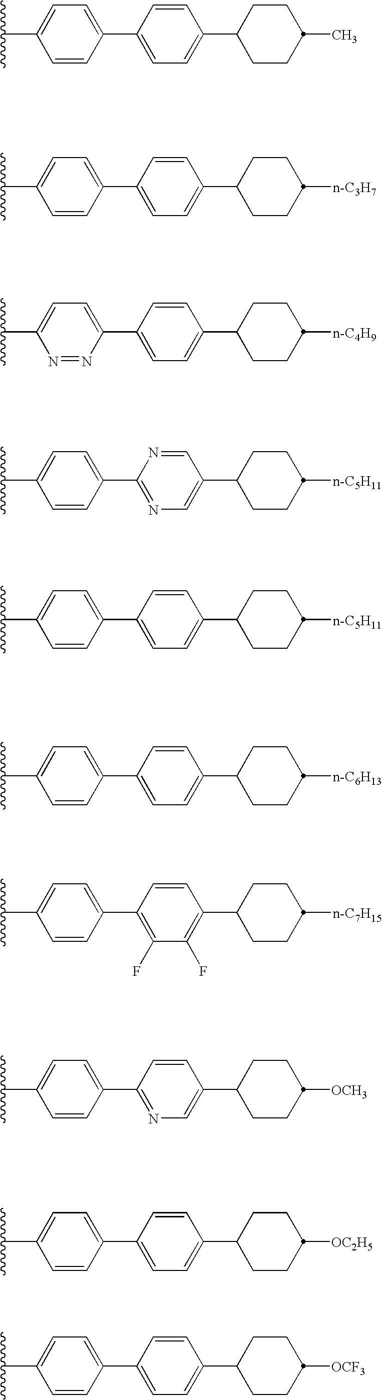

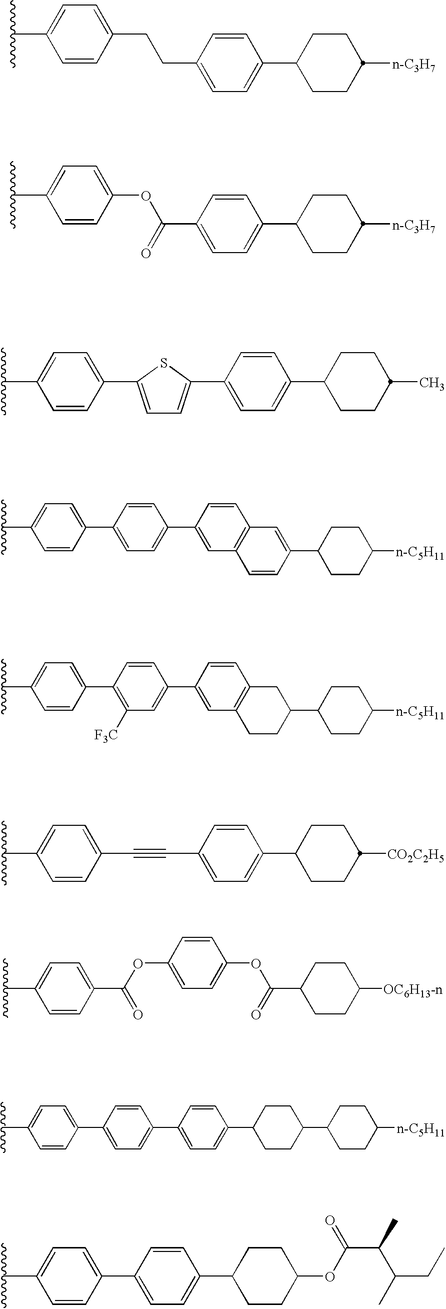

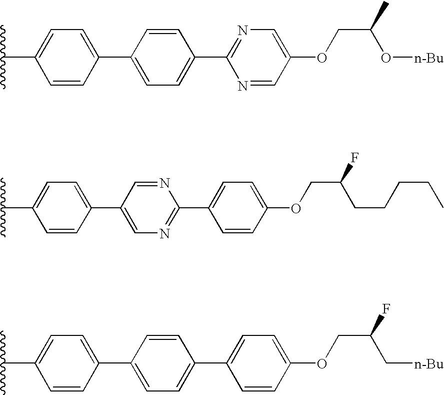

The number of the substituent groups represented by the above-mentioned general formula (a) in the above-mentioned dichroic dye is preferably from 1 to 8, more preferably from 1 to 4, and particularly preferably 1 or 2.

As a dye for yellow Y, there can be suitably used an anthraquinone compound represented by the following general formula (1): 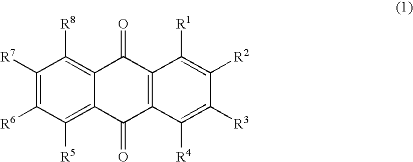
wherein R¹ represents a substituent group represented by —S—((B¹)ₚ-(Q¹)_{q}-(B²)ᵣ)ₙ—C¹, wherein S represents a sulfur atom, B¹, B², Q¹, p, q, r and n have the same meanings as defined in the above-mentioned general formula (a), and preferred examples thereof are also the same as those for general formula (a).

R², R³, R⁴, R⁵, R⁶, R⁷ and R⁸ each independently represents a hydrogen atom or a substituent group. The substituent groups represented by R²to R⁸ include anyone substituent group selected from the above-mentioned group of substituent groups V.

In the above-mentioned general formula (1), a combination of p=2, q=0, r=1 and n=1 is preferred, and it is preferred that B¹, B² and C¹ represent an aryl group, a 1,4-cyclohexanediyl group and an alkyl group, respectively.

Of the anthraquinone dyes represented by the above-mentioned general formula (1), more preferred are anthraquinone dyes represented by the following general formulas (2) to (4): 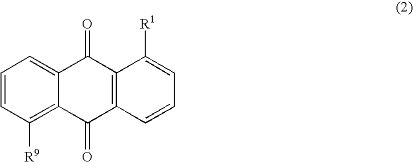
wherein R¹ represents a substituent group represented by —S—((B¹)ₚ-(Q¹)_{q}-(B²)ᵣ)ₙ—C¹, wherein S represents a sulfur atom, B¹, B², Q¹, p, q, r and n have the same meanings as defined in the above-mentioned general formula (a), and preferred examples thereof are also the same as those for general formula (a).

In the above-mentioned general formula (2) , R⁹ represents an arylthio group or a heteroarylthio group. The arylthio group is an arylthio group having preferably 6 to 80 carbon atoms, more preferably 6 to 40 carbon atoms, and still more preferably 6 to 30 carbon atoms (for example, a phenylthio group, a p-methylphenylthio group, a p-chlorophenylthio group, a 4-methylphenylthio group, a 4-ethylphenylthio group, a 4-n-propylphenylthio group, a 2-n-butylphenylthio group, a 3-n-butylphenylthio group, a 4-n-butylphenylthio group, a 2-t-butylphenylthio group, a 3-t-butylphenylthio group, a 4-t-butylphenylthio group, a 3-n-pentylphenylthio group, a 4-n-pentylphenylthio group, a 4-amylpentylphenylthio group, a 4-hexylphenylthio group, a 4-heptylphenylthio group, a 4-octylphenylthio group, a 4-trifluoromethylphenylthio group, a 4-trifluoromethylphenylthio group, a 1-naphthylthio group, a 2-naphthylthio group, a 4-propylcyclohexyl-4′-biphenylthio group, a 4-pentylcyclohexyl-4′-biphenylthio group or a 4-propylphenyl-2-ethynyl-4′-biphenylthio group, and the heteroarylthio group is a heteroarylthio group having preferably 1 to 80 carbon atoms, more preferably 1 to 40 carbon atoms, and still more preferably 1 to 30 carbon atoms (for example, a 2-pyridylthio group, a 3-pyridylthio group, a 4-pyridylthio group, a 2-quinolylthio group, a 2-furylthio group or a 2-pyrrolylthio group). R⁹may further have a substituent group, which includes any one substituent group selected from the above-mentioned group of substituent groups V.

R⁹ is preferably an arylthio group, and particularly preferably an arylthio group having an alkyl group at the 3- or 4-position.

Specific examples of the anthraquinone compounds represented by the above-mentioned general formula (2) are shown below, but the invention should not be construed as being limited by the following specific examples.

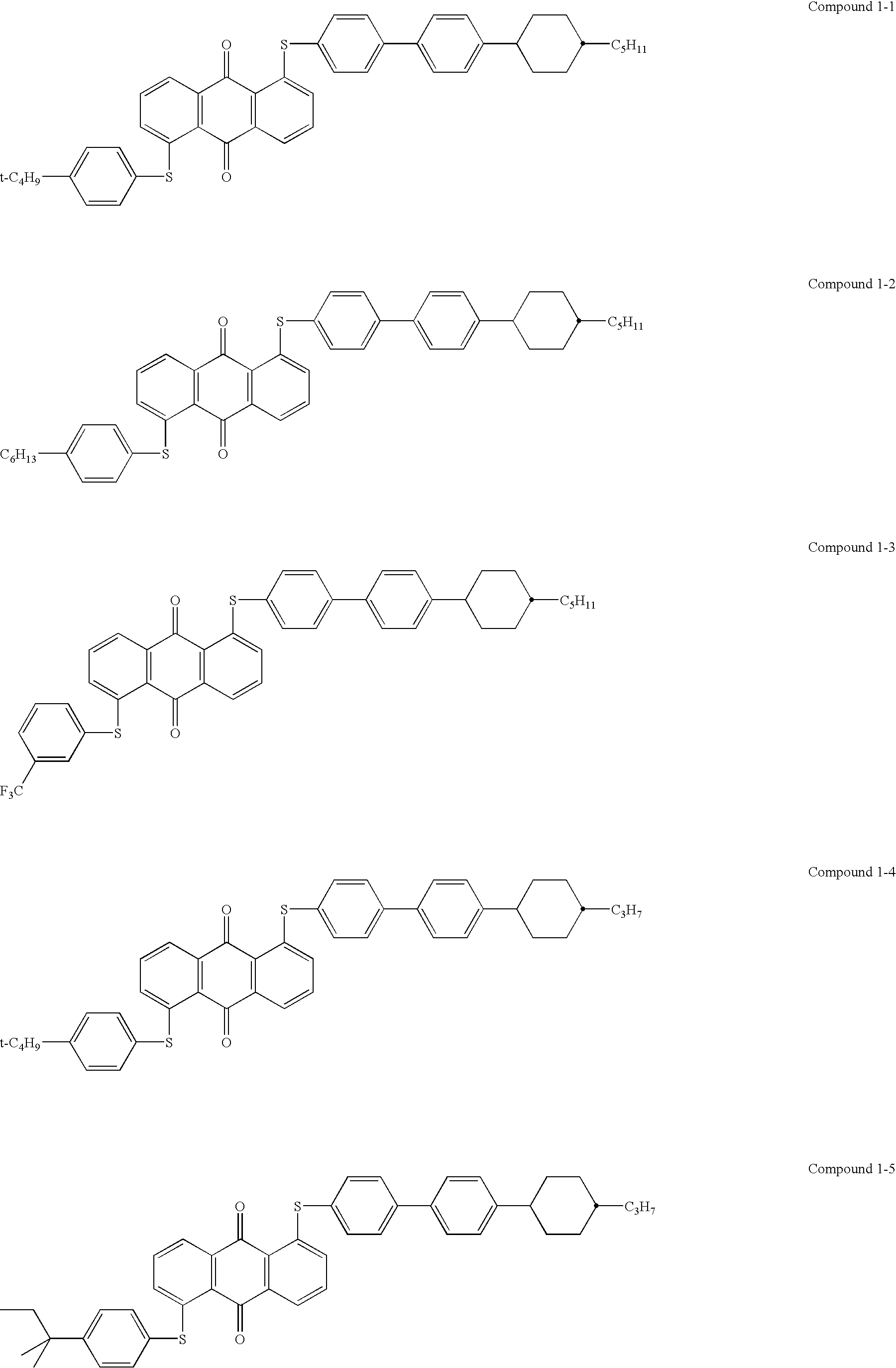

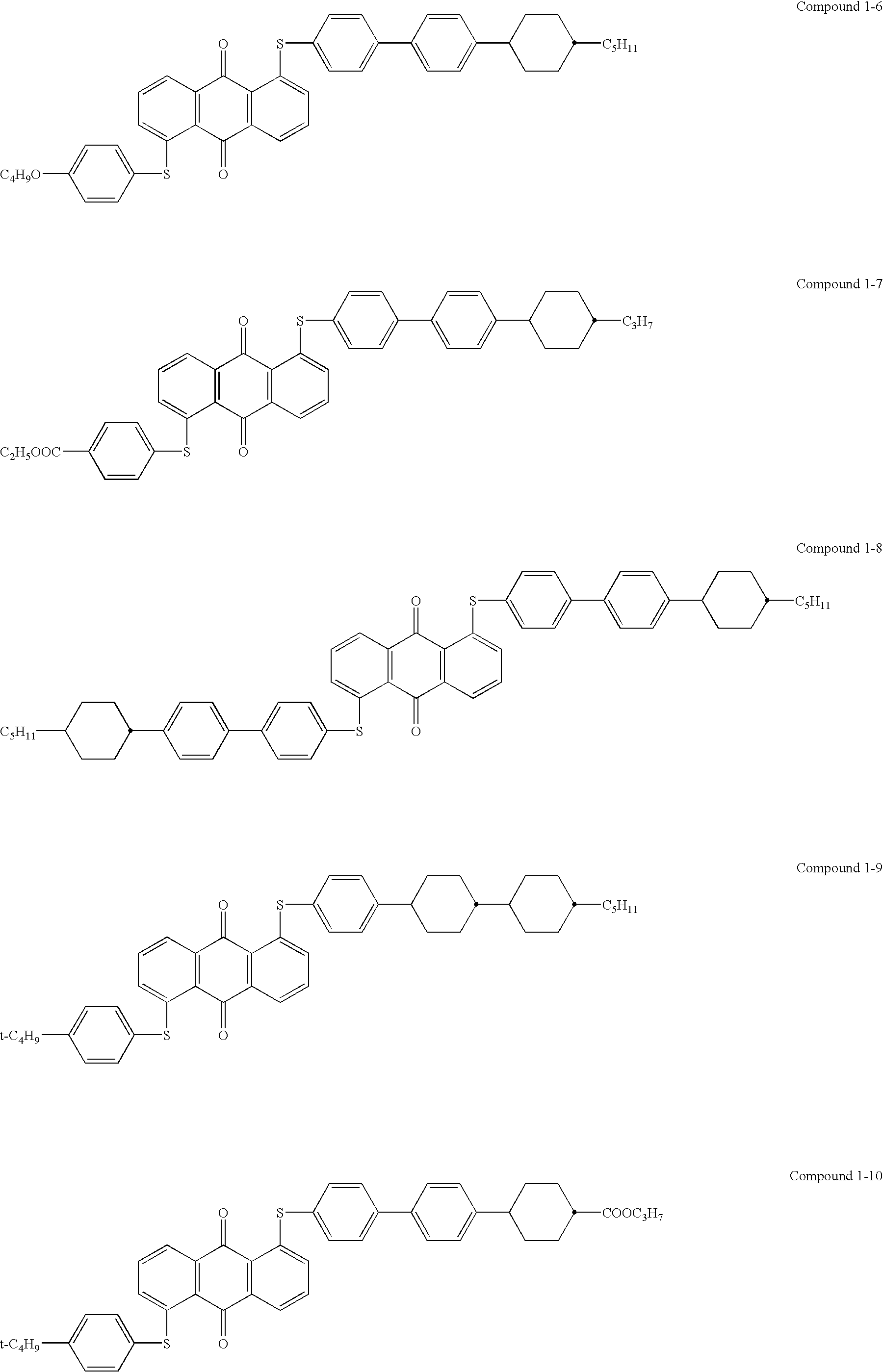

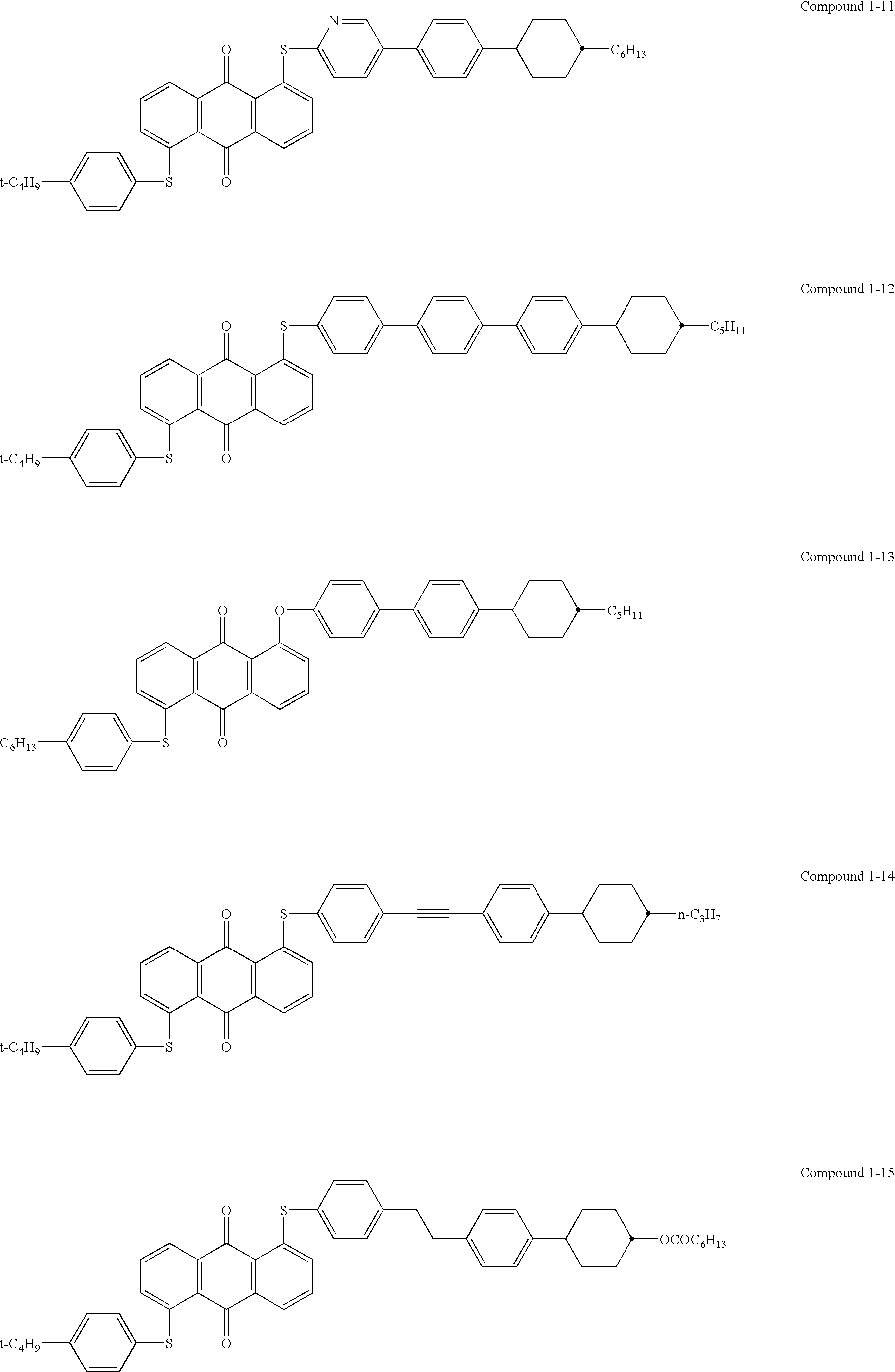

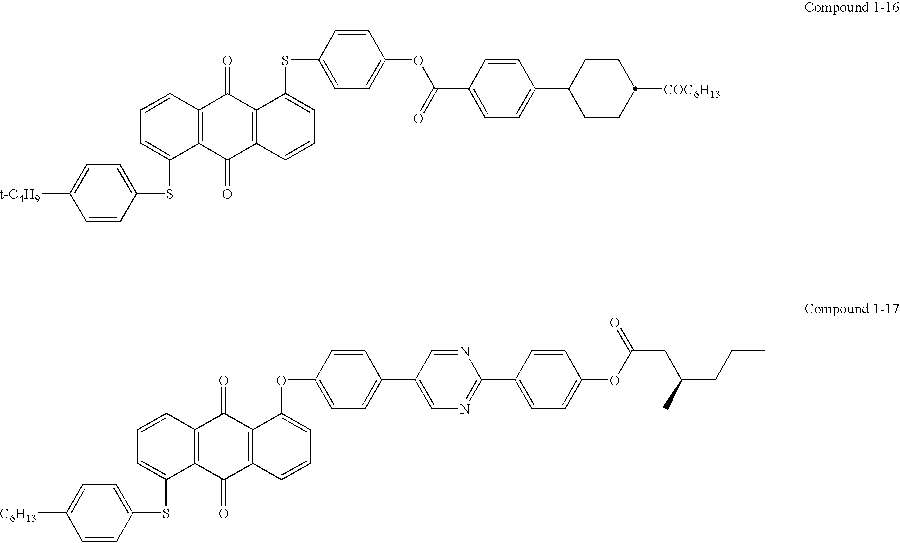

The anthraquinone dyes represented by the following general formula (3) will be described in detail below. (3) 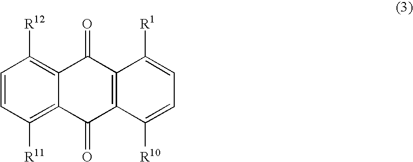
wherein R¹ represents a substituent group represented by —S—((B¹)ₚ-(Q¹)_{q}-(B²)ᵣ)ₙ—C¹, wherein S represents a sulfur atom, B¹, B², Q¹, p, q, r and n have the same meanings as defined in the above-mentioned general formula (a), and preferred examples thereof are also the same as those for general formula (a), and R¹⁰, R¹¹ and R¹² each independently represents an arylthio group or a heteroarylthio group. The arylthio group and the heteroarylthio group represented by each of R¹⁰, R¹¹ and R¹² have the same meanings as defined for those represented by R⁹ in the above-mentioned general formula (2), and preferred examples thereof are also the same as those for general formula (2).

Specific examples of the anthraquinone compounds represented by the above-mentioned general formula (3) are shown below, but the invention should not be construed as being limited by the following specific examples.

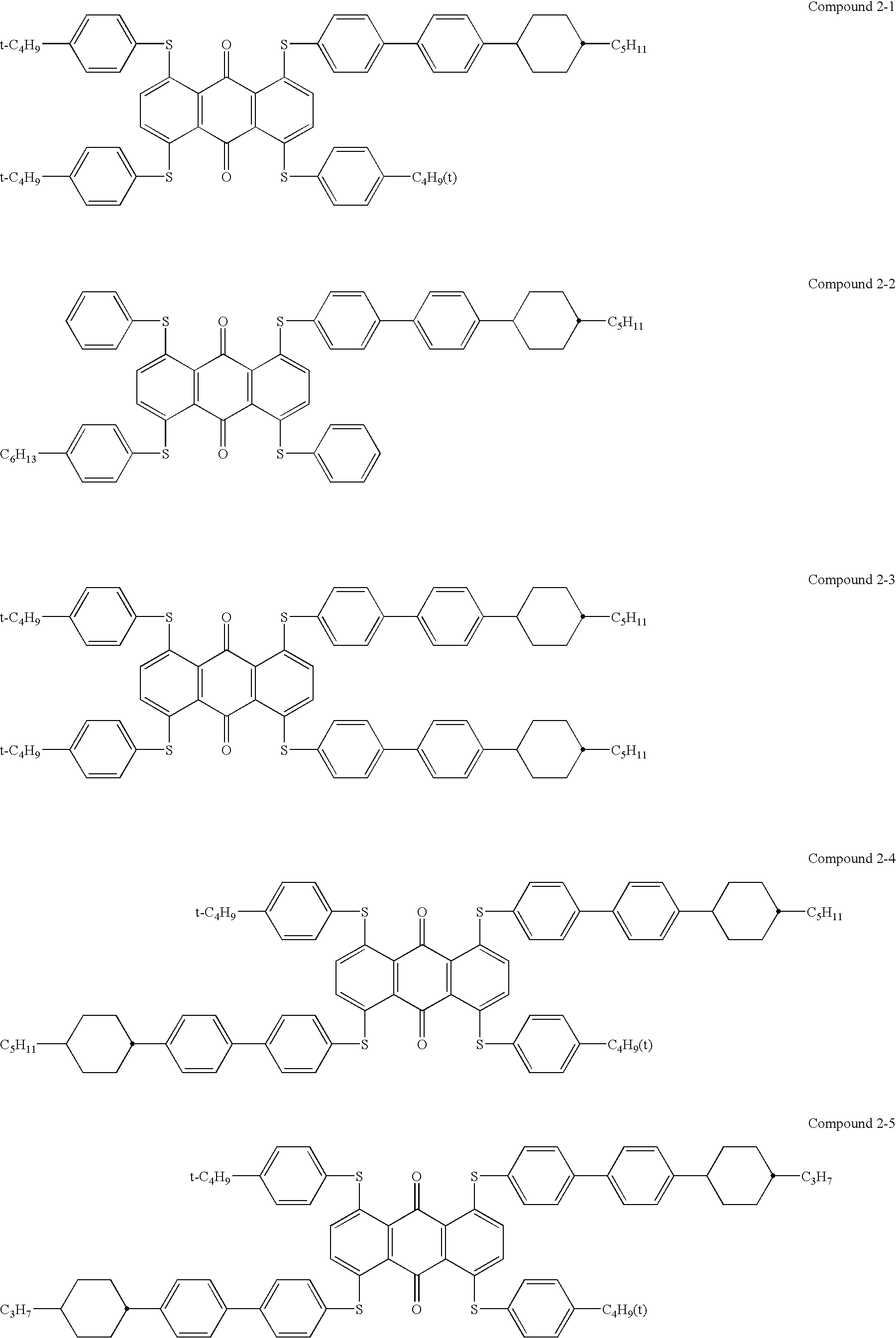

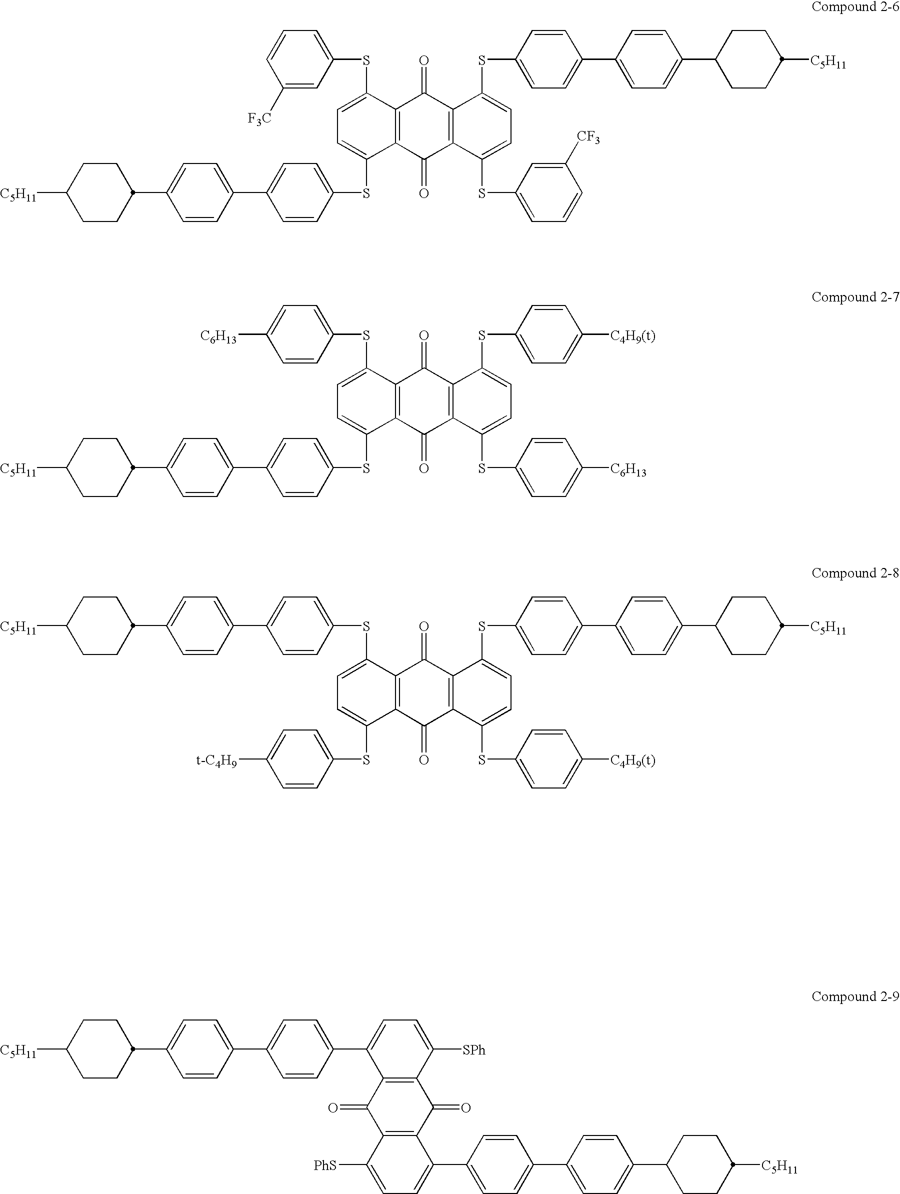

The anthraquinone dyes represented by the following general formula (4) will be described in detail below. 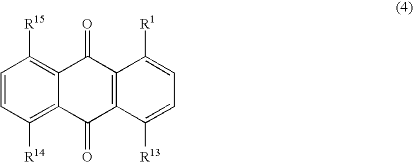
wherein R¹ represents a substituent group represented by —S—((B¹)ₚ-(Q¹)_{q}-(B²)ᵣ)ₙ—C¹, wherein S represents a sulfur atom, B¹, B², Q¹, p, q, r and n have the same meanings as defined in the above-mentioned general formula (a), and preferred examples thereof are also the same as those for general formula (a).

In the above-mentioned general formula (4), R¹³, R¹⁴ and R¹⁵ each represents an arylthio group, a heteroarylthio group, a substituted or unsubstituted amino group, an acylamino group or a hydroxyl group. However, at least one of R¹³, R¹⁴ and R¹⁵ is a substituted or unsubstituted amino group, an acylamino group or a hydroxyl group. The above-mentioned arylthio group and heteroarylthio group have the same meanings as defined for those represented by R⁹ in the above-mentioned general formula (2), and preferred examples thereof are also the same as those for general formula (2). The substituted amino group represented by each of R¹³ to R¹⁵ is preferably an amino group substituted with an alkyl group, an aryl group or a heteroaryl group. Specific examples thereof include a methylamino group, a dimethylamino group, a benzylamino group, an anilino group, a diphenylamino group, a 4-methylphenylamino group, a 4-ethylphenylamino group, a 3-n-propylphenylamino group, a 4-n-propylphenylamino group, a 3-n-butylphenylamino group, a 4-n-butylphenylamino group, a 3-n-pentylphenylamino group, a 4-n-pentylphenylamino group, a 3-trifluoromethylphenylamino group, a 4-trifluoromethylphenylamino group, a 2-pyridylamino group, a 3-pyridylamino group, a 2-thiazolylamino group, a 2-oxazolylamino group, an N,N-methylphenylamino group and an N,N-ethylphenylamino group. R¹⁴ and R¹⁵are each preferably an unsubstituted amino group or an arylamino group, and particularly preferably an arylamino group. The acylamino group represented by each of R¹³ to R¹⁵ is preferably an acylamino group substituted with an alkyl group, an aryl group or a heteroaryl group.

Specific examples of the anthraquinone compounds represented by the above-mentioned general formula (4) are shown below, but the invention should not be construed as being limited by the following specific examples.

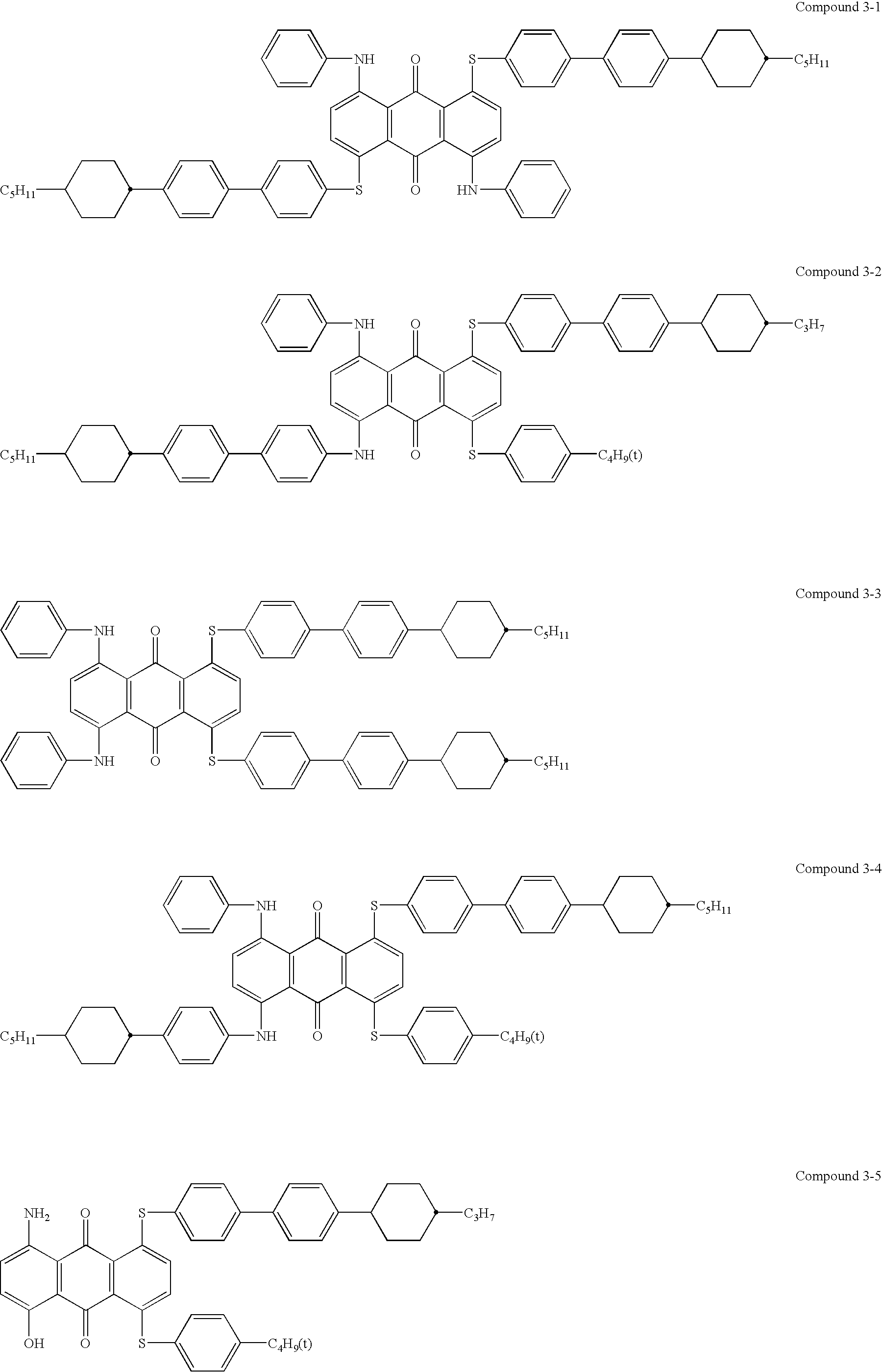

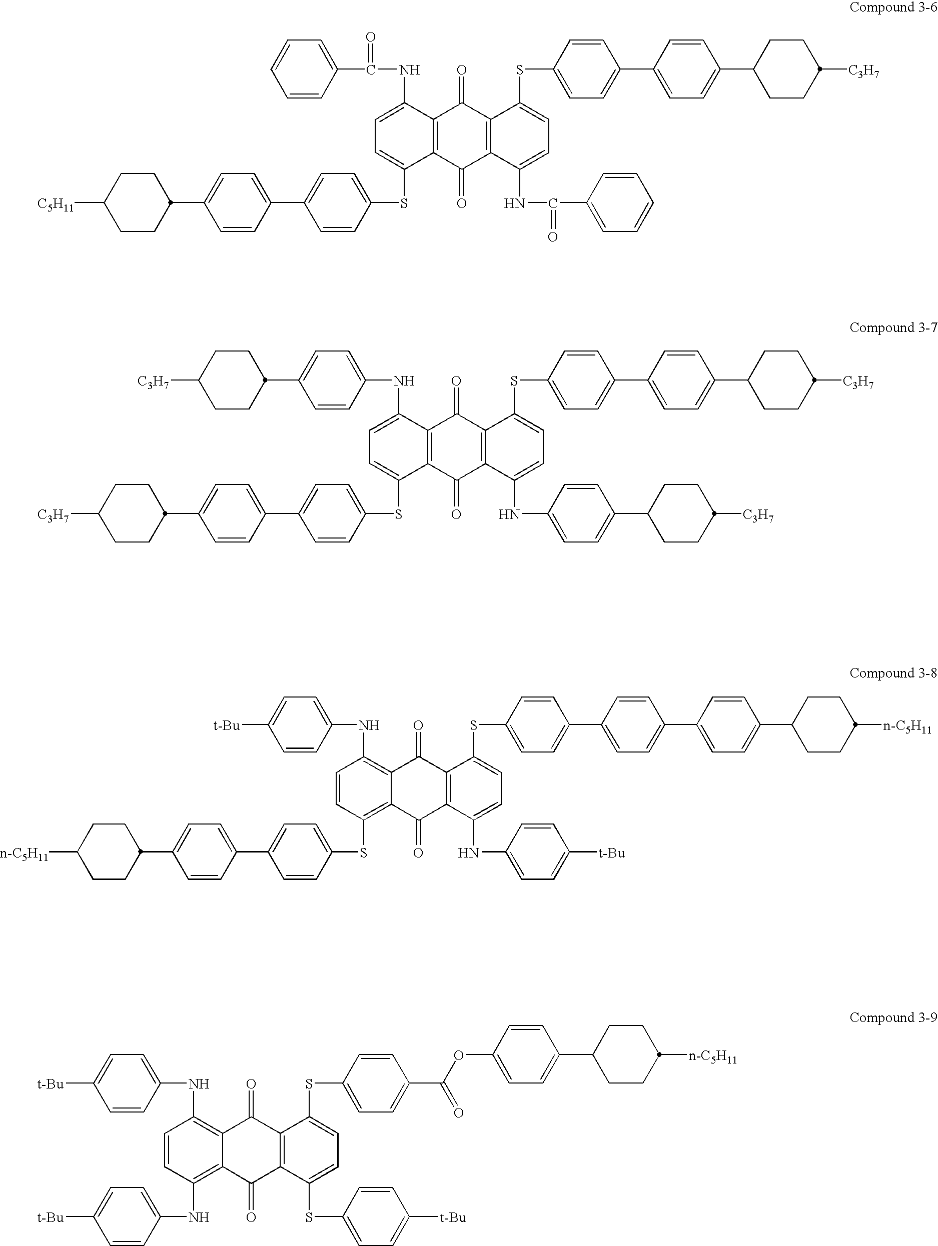

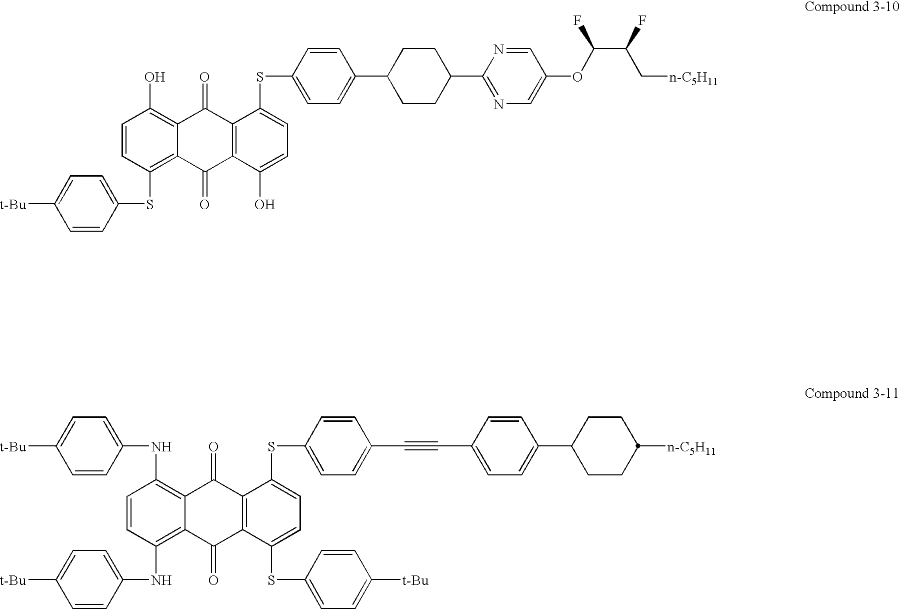

### EXAMPLES

An example of a display element according to the invention will be described below.

The constitution of a display element of this example is the same as that of the display element 10 described in the above-mentioned embodiment.

Further, in this example, MLC-6608 manufactured by Merck & Co., Inc. was used as a liquid crystal.

In this example, LCD-6608 manufactured by Nippon Kayaku Co., Ltd. was used as a dye for cyan C, a mixture of the above-mentioned compound 2-1 and compound 2-2 at a molar ratio of 1:1 was used as a dye for magenta M, and a mixture of the above-mentioned compound 1-1, compound 1-2 and compound 1-3 at a molar ratio of 1:1:1 was used as a dye for yellow Y.

On the other hand, as a display element of a comparative example, there was used a display element 9 shown in FIG. 9, which has the two-layer three-pixel structure as shown in FIG. 10. The display element 9 was constituted so that primary color regions 91a, 91b and 91c each contains two of primary colors C, M and T to allow any one of primary colors R, G and B to appear by color mixture by superposition. In the display element 9 of the comparative example, dyes for cyan C, magenta M and Yellow Y were the same as those of the example.

As a result of measurements, the color reproducibility of both the display elements in the example and the comparative example was good. However, the display element of the example was remarkably improved in resolution, compared to the display element of the comparative example.

The present invention is not limited to the specific above-described embodiments. It is contemplated that numerous modifications may be made to the present invention without departing from the spirit and scope of the invention as defined in the following claims.

1. A display element for displaying full colors, comprising two colored layers including an upper colored layer and a lower colored layer which are laminated with each other,
wherein the upper colored layer has two upper colored regions which are arranged optically in parallel to each other, the upper colored regions each containing a dye to display a different hue, and
the lower colored layer has two lower colored regions which are arranged optically in parallel to each other, the lower colored regions each containing a dye to display a different hue.

2. The display element according to claim 1, wherein each of the upper colored regions and each of the lower colored regions all display different hues.

3. The display element according to claim 1, wherein one of the upper colored regions has a first hue, a lower colored region arranged in a lamination direction with respect to the one of the upper colored regions has a second hue, and the first hue and the second hue have a relation of complimentary colors to each other.

4. The display element according to claim 1, wherein one of the two upper colored regions has a hue of green, and other of the two upper colored regions has a hue of blue.

5. The display element according to claim 1, wherein one of the two lower colored regions has a hue of green, and other of the two lower colored regions has a hue of blue.

6. The display element according to claim 1, wherein each of the dyes are selected from a cyan dye, a magenta dye and a yellow dye which are subtractive primary colors.

7. The display element according to claim 1, wherein the dye is a dichroic dye.

8. The display element according to claim 1, which comprises a reflective layer.

9. The display element according to claim 1, wherein the two upper colored regions each independently includes two kinds of dyes selected from a cyan dye, a magenta dye, and the yellow dye.

10. The display element according to claim 1, wherein all of the upper colored regions and the lower colored regions each has a driving element in such a manner that each driving element is controllably driven, thereby being able to independently apply voltage to the respective colored regions of liquid crystal layers.
